(19) United States
(12) Patent Application Publication
(10) Pub. No.: US 2022/0322362 A1
(43) Pub. Date: Oct. 6, 2022

(54) MULTI-TRP TRANSMISSION FOR DOWNLINK SEMI-PERSISTENT SCHEDULING

(71) Applicant: Telefonaktiebolaget LM Ericsson (publ), Stockholm (SE)

(72) Inventors: Siva Muruganathan, Stittsville (CA); Shiwei Gao, Nepean (CA); Yufei Blankenship, Kildeer, IL (US); Mattias Frenne, Uppsala (SE)

(21) Appl. No.: 17/608,723

(22) PCT Filed: May 1, 2020
(86) PCT No.: PCT/IB2020/054166

§ 371 Date: Nov. 3, 2021

Related U.S. Application Data
(60) Provisional application No. 62/843,093, filed on May 3, 2019.

(51) Int. Cl. H04W 72/08; H04W 72/04

(52) U.S. Cl. CPC H04W 72/085; H04W 72/042; H04W 72/0446; H04W 72/0453

(57) ABSTRACT

Systems and methods for multi-Transmission Reception Point (TRP) transmission for downlink Semi-Persistent Scheduling (SPS) are provided. In some embodiments, a method performed by a wireless device for configuring one or more wireless communications settings includes determining multiple wireless communications configurations; and simultaneously activating at least two of the wireless communications configurations such that the at least two of the plurality of wireless communications configurations include configuration of one or more of a low latency and/or reliability scheme and one or more properties related to the low latency and/or reliability scheme. This enables multi-TRP based reliability schemes for the case when multiple downlink SPS configurations can be simultaneously activated. By independently configuring low latency and/or reliability schemes and properties of such schemes to different downlink SPS configurations, different reliability and/or low latency schemes can be flexibly applied to different downlink SPS configurations that may be associated with different traffic profiles.

### RELATED APPLICATIONS

This application claims the benefit of provisional patent application Ser. No. 62/843,093, filed May 3, 2019, the disclosure of which is hereby incorporated herein by reference in its entirety.

### TECHNICAL FIELD

The current disclosure relates to multi-Transmission Reception Point (TRP) transmission.

### BACKGROUND

The new generation mobile wireless communication system (5G) or New Radio (NR) supports a diverse set of use cases and a diverse set of deployment scenarios. NR uses Cyclic Prefix Orthogonal Frequency Division Multiplexing (CP-OFDM) in the downlink (i.e. from a network node, New Radio Base Station (gNB), evolved or enhanced NodeB (eNB), or base station, to a User Equipment (UE)) and both CP-OFDM and Discrete Fourier Transform-spread OFDM (DFT-S-OFDM) in the uplink (i.e. from UE to gNB). In the time domain, NR downlink and uplink physical resources are organized into equally-sized subframes of 1 ms each. A subframe is further divided into multiple slots of equal duration.

The slot length depends on subcarrier spacing. For subcarrier spacing of Δf=15 kHz, there is only one slot per subframe and each slot always consists of 14 OFDM symbols, irrespective of the subcarrier spacing.

Typical data scheduling in NR are per slot basis. An example is shown in FIG. 1 where the first two symbols contain Physical Downlink Control Channels (PDCCHs), and the remaining 12 symbols contain physical data channels (PDCHs), either a Physical Downlink Shared Channel (PDSCH) or Physical Uplink Shared Channel (PUSCH).

Different subcarrier spacing values are supported in NR. The supported subcarrier spacing values (also referred to as different numerologies) are given by Δf=(15×2^{α}) kHz where α is a non-negative integer. Δf=15 kHz is the basic subcarrier spacing that is also used in LTE. The slot durations at different subcarrier spacings are shown in Table 1.

TABLE 1
Slot length at different numerologies.

| | | |
|---|---|---|
| Numerology | Slot length | RB BW |

| | | | | | |
|---|---|---|---|---|---|
| 15 | kHz | 1 | ms | 180 | kHz |
| 30 | kHz | 0.5 | ms | 360 | kHz |
| 60 | kHz | 0.25 | ms | 720 | kHz |
| 120 | kHz | 125 | μs | 1.44 | MHz |
| 240 | kHz | 62.5 | μs | 2.88 | MHz |

In the frequency domain physical resource definition, a system bandwidth is divided into resource blocks (RBs), where each RB corresponds to 12 contiguous subcarriers. The common RBs (CRB) are numbered starting with 0 from one end of the system bandwidth. The UE is configured with one or up to four bandwidth part (BWPs) which may be a subset of the RBs supported on a carrier. Hence, a BWP may start at a CRB larger than zero. All configured BWPs have a common reference, the CRB 0. Hence, a UE can be configured a narrow BWP (e.g., 10 MHz) and a wide BWP (e.g., 100 MHz), but only one BWP can be active for the UE at a given point in time. The physical RBs (PRB) are numbered from 0 to N−1 within a BWP (but the 0^{th} PRB may thus be the K^{th} CRB where K>0).

The basic NR physical time-frequency resource grid is illustrated in FIG. 2, where only one resource block (RB) within a 14-symbol slot is shown. One OFDM subcarrier during one OFDM symbol interval forms one resource element (RE).

Downlink transmissions can be dynamically scheduled, i.e., in each slot the gNB transmits Downlink Control Information (DCI) over PDCCH about which UE data is to be transmitted to and which RBs in the current downlink slot the data is transmitted on. PDCCH is typically transmitted in the first one or two OFDM symbols in each slot in NR. The UE data are carried on PDSCH. A UE first detects and decodes PDCCH, and if the decoding is successful, it then decodes the corresponding PDSCH based on the decoded control information in the PDCCH.

Uplink data transmission can also be dynamically scheduled using PDCCH. Similar to downlink, a UE first decodes uplink grants in PDCCH and then transmits data over PUSCH based the decoded control information in the uplink grant such as modulation order, coding rate, uplink resource allocation, etc.

Several signals can be transmitted from the same base station antenna from different antenna ports. These signals can have the same large-scale properties, for instance, in terms of Doppler shift/spread, average delay spread, or average delay. These antenna ports are then said to be Quasi Co-Located (QCL).

The network can then signal to the UE that two antenna ports are QCL. If the UE knows that two antenna ports are QCL with respect to a certain parameter (e.g., Doppler spread), the UE can estimate that parameter based on one of the antenna ports and use that estimate when receiving the other antenna port. Typically, the first antenna port is represented by a measurement reference signal such as a Channel State Information Reference Signal (CSI-RS) (known as source Reference Signal (RS)), and the second antenna port is a Demodulation Reference Signal (DMRS) (known as target RS).

For instance, if antenna ports A and B are QCL with respect to average delay, the UE can estimate the average delay from the signal received from antenna port A (known as the source Reference Signal (RS)) and assume that the signal received from antenna port B (target RS) has the same average delay. This is useful for demodulation since the UE can know beforehand the properties of the channel when trying to measure the channel utilizing the DMRS.

Information about what assumptions can be made regarding QCL is signaled to the UE from the network. In NR, four types of QCL relations between a transmitted source RS and transmitted target RS were defined:
Type A: {Doppler shift, Doppler spread, average delay, delay spread}
Type B: {Doppler shift, Doppler spread}
Type C: {average delay, Doppler shift}
Type D: {Spatial Rx parameter}

QCL type D was introduced to facilitate beam management with analog beamforming and is known as spatial QCL. There is currently no strict definition of spatial QCL, but the understanding is that if two transmitted antenna ports are spatially QCL, the UE can use the same Rx beam to receive them. Note that for beam management, the discussion mostly revolves around QCL Type D, but it is also necessary to convey a Type A QCL relation for the RSs to the UE so that it can estimate all the relevant large scale parameters.

Typically this is achieved by configuring the UE with a CSI-RS for tracking (Tracking Reference Signal, or TRS) for time/frequency offset estimation. To be able to use any QCL reference, the UE would have to receive it with a sufficiently good Signal to Interference plus Noise Ratio (SINR). In many cases, this means that the TRS has to be transmitted in a suitable beam to a certain UE.

To introduce dynamics in beam and Transmission Reception Point (TRP) selection, the UE can be configured through Radio Resource Control (RRC) signaling with N Transmission Configuration Indicator (TCI) states, where N is up to 128 in Frequency Range 2 (FR2) and up to 8 in FR1, depending on UE capability.

Each TCI state contains QCL information, i.e., one or two source Downlink (DL) RSs, each source RS associated with a QCL type. For example, a TCI state contains a pair of reference signals, each associated with a QCL type, e-g—two different CSI-RSs {CSI-RS1, CSI-RS2} is configured in the TCI state as {qcl-Type1, qcl-Type2}={Type A, Type D}. It means the UE can derive Doppler shift, Doppler spread, average delay, delay spread from CSI-RS1 and Spatial Rx parameter (i.e., the RX beam to use) from CSI-RS2. In case type D (spatial information) is not applicable, such as low or midband operation, then a TCI state contains only a single source RS.

Each of the N states in the list of TCI states can be interpreted as a list of N possible beams transmitted from the network or a list of N possible TRPs used by the network to communicate with the UE.

A first list of available TCI states is configured for PDSCH, and a second list for PDCCH contains pointers, known as TCI State IDs, to a subset of the TCI states configured for PDSCH. The network then activates one TCI state for PDCCH (i.e., provides a TCI for PDCCH) and up to eight active TCI states for PDSCH. The number of active TCI states the UE support is a UE capability but the maximum is eight.

Each configured TCI state contains parameters for the quasi co-location associations between source reference signals (CSI-RS or Synchronization Signal (SS)/Physical Broadcasting Channel (PBCH)) and target reference signals (e.g., PDSCH/PDCCH DMRS ports). TCI states are also used to convey QCL information for the reception of CSI-RS.

Assume a UE is configured with four active TCI states (from a list of totally 64 configured TCI states). Hence, 60 TCI states are inactive and the UE need not be prepared to have large scale parameters estimated for those. But the UE continuously tracks and updates the large scale parameters for the four active TCI states by measurements and analysis of the source RSs indicated by each TCI state.

In NR Rel-15, when scheduling a PDSCH to a UE, the DCI contains a pointer to one active TCI. The UE then knows which large scale parameter estimate to use when performing PDSCH DMRS channel estimation and thus PDSCH demodulation.

Demodulation reference signals are used for coherent demodulation of physical layer data channels, PDSCH (DL) and PUSCH (Uplink (UL)), as well as of physical layer downlink control channel PDCCH. The DMRS is confined to resource blocks carrying the associated physical layer channel and is mapped on allocated resource elements of the OFDM time-frequency grid such that the receiver can efficiently handle time/frequency-selective fading radio channels.

The mapping of DMRS to resource elements is configurable in both frequency and time domain, with two mapping types in the frequency domain (configuration type 1 or type 2) and two mapping types in the time domain (mapping type A or type B) defining the symbol position of the first DMRS within a transmission interval. The DMRS mapping in time domain can further be single-symbol based or double-symbol based where the latter means that DMRS is mapped in pairs of two adjacent symbols. Furthermore, a UE can be configured with one, two, three, or four single-symbol DMRS and one or two double-symbol DMRS. In scenarios with low Doppler, it may be sufficient to configure front-loaded DMRS only, i.e., one single-symbol DMRS or one double-symbol DMRS, whereas in scenarios with high Doppler additional DMRS will be required.

FIG. 3A shows the mapping of front-loaded DMRS for configuration type 1 and type 2 with single-symbol and double-symbol DMRS and for the mapping type A with first DMRS in third symbol of a transmission interval of 14 symbols. This Figure demonstrates that type 1 and type 2 differ with respect to both the mapping structure and the number of supported DMRS Code Division Multiplexing (CDM) groups where type 1 supports two CDM groups, and Type 2 support three CDM groups.

The mapping structure of type 1 is sometimes referred to as a 2-comb structure with two CDM groups defined, in frequency domain, by the set of subcarriers {0, 2, 4, . . . } and {1, 3, 5, . . . }. The comb mapping structure is a prerequisite for transmissions requiring low PAPR/CM and is thus used in conjunction with DFT-S-OFDM, whereas in CP-OFDM both type 1 and type 2 mapping are supported.

A DMRS antenna port is mapped to the resource elements within one CDM group only. For single-symbol DMRS, two antenna ports can be mapped to each CDM group whereas for double-symbol DMRS four antenna ports can be mapped to each CDM group. Hence, the maximum number of DMRS ports is for type 1 either four or eight and for type 2 it is either six or twelve. An Orthogonal Cover Code (OCC) of length 2 ([+1, +1], [+1, −1]) is used to separate antenna ports mapped on same resource elements within a CDM group. The OCC is applied in frequency domain as well as in time domain when double-symbol DMRS is configured.

The downlink control information (DCI) contains a bit field that selects which antenna ports and the number of antenna ports (i.e., the number of data layers) is scheduled. For example, if port 1000 is indicated, then the PDSCH is a single layer transmission and the UE will use the DMRS defined by port 1000 to demodulate the PDSCH.

An example is shown in Table 2 below for DMRS Type 1 and with a single front loaded DMRS symbol (maxLength=1). The DCI indicates a value and the number of DMRS ports is given. The Value also indicates the number of CDM groups without data, which means that if one is indicated, the other CDM group does contain data for the UE (PDSCH case). If the value is two, both CDM groups may contains DMRS ports and no data is mapped to the OFDM symbol contains the DMRS.

For DMRS Type 1, ports 1000, 1001, 1004, and 1005 are in CDM group λ=0 and ports 1002, 1003, 1006, and 1007 are in CDM group λ=1. This is also indicated in Table 1.

Table 3 shows the corresponding table for DMRS Type 2. For DMRS Type 2 ports 1000, 1001, 1006, and 1007 are in CDM group λ=0 and ports 1002, 1003, 1008, and 1009 are in CDM group λ=1. Ports 1004, 1005, 1010, and 1011 are in CDM group λ=2. This is also indicated in Table 2.

Other tables for other DMRS configurations can be found in TS 38.212.

TABLE 2
Antenna port(s) (1000 + DMRS port), dmrs-Type = 1, maxLength = 1
One Codeword: Codeword 0 enabled, Codeword 1 disabled

| | Number of DMRS CDM | DMRS |
|---|---|---|
| Value | group(s) without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12-15 | Reserved | Reserved |

TABLE 3
Antenna port(s) (1000 + DMRS port), dmrs-Type = 2, maxLength = 1

| One codeword: Codeword 0 enabled, | | | Two codewords: Codeword 0 enabled, | | |
|---|---|---|---|---|---|
| Codeword 1 disabled | | | Codeword 1 enabled | | |
| | Number of DMRS CDM | DMRS | | Number of DMRS CDM | DMRS |
| Value | group(s) without data | port(s) | Value | group(s) without data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24-31 | Reserved | Reserved | | | |

QCL relation to DMRS CDM groups. In NR specifications, there is a restriction stating: The UE may assume that the PDSCH DMRS within the same CDM group are quasi co-located with respect to Doppler shift, Doppler spread, average delay, delay spread, and spatial Rx.

In cases where a UE is not scheduled all DMRS ports within a CDM group, there may be another UE simultaneously scheduled, using the remaining ports of that CDM group. The UE can then estimate the channel for that other UE (thus an interfering signal) in order to perform coherent interference suppression. Hence, this is useful in MU-MIMO scheduling and UE interference suppression.

Ultra Reliable Low Latency Communication (URLLC) services are considered to be one of the key features supported by 5G. These are the services for latency sensitive devices for applications like factory automation, electric power distribution, and remote driving. These services have strict reliability and latency requirements, e.g., at least 99.999% reliability within 1 ms one-way latency.

RRC configuration of number of repetitions in Rel-15. In NR Rel-15, slot-aggregation is supported both for DL and UL transmissions which is beneficial for enhancing the coverage and improved reliability. In this case, the PDSCH and PUSCH transmissions can be repeated in multiple slots when the RRC parameter for slot aggregation is configured. The corresponding RRC parameter is referred to as pdsch-AggregationFactor, pusch-AggregationFactor, repK for PDSCH, grant based PUSCH and grant-free PUSCH, respectively. The relevant Information Elements (IEs) from TS 38.331 are listed below to illustrate the usage of these parameters.

### PDSCH-Config Information Element

| | |
|---|---|
| -- ASN1START | |
| -- TAG-PDSCH-CONFIG-START | |
| PDSCH-Config : := | SEQUENCE { |
| ... | |
| resourceAllocation | ENUMERATED { resourceAllocationType0, |

resourceAllocationType1, dynamicSwitch},

| | |
|---|---|
| pdsch-TimeDomainAllocationList | SetupRelease { PDSCH- |
| TimeDomainResourceAllocationList } | OPTIONAL, -- Need M |
| pdsch-AggregationFactor | ENUMERATED { n2, n4, n8 } |
| ... | |
| } | |

### PUSCH-Config Information Element

| | |
|---|---|
| PUSCH-Config : := | SEQUENCE { |
| ... | |
| resourceAllocation | ENUMERATED { resourceAllocationType0, |

resourceAllocationType1, dynamicSwitch},

| pusch-TimeDomainAllocationList | | SetupRelease { PUSCH- |
|---|---|---|
| TimeDomainResourceAllocationList } | | OPTIONAL, -- Need |
| M | | |
| pusch-AggregationFactor | | ENUMERATED { n2, n4, n8 } |
| | OPTIONAL, | -- Need S |

...
}

### ConfiguredGrantConfig Information Element

| | |
|---|---|
| ConfiguredGrantConfig : := | SEQUENCE { |
| ... | |
| repK | ENUMERATED {n1, n2, n4, n8}, |
| ... | |
| } | |

When a UE is scheduled by DL assignment or DL Semi-Persistent Scheduling (SPS) for PDSCH transmission in a given slot, the signalled resource allocation for the PDSCH is used for a number of consecutive slots if an aggregation factor is configured with a value larger than 1. In this case, the PDSCH is repeated with different redundancy versions in those slots for transmission of a corresponding transport block (TB). The same procedure is applied for UL where a UE is scheduled by UL assignment or grant-free for PUSCH transmission in a slot and is configured for slot aggregations. In this case, the UE uses the signalled resource allocation in the number of slots given by the aggregation factors using different redundancy versions for the transmission of a corresponding TB. The redundancy version to be applied on the n^{th} transmission occasion of the TB is determined according to table below, where rv_{id} is the Redundancy Version (RV) identity number.

TABLE 5.1.2.1-2
Applied redundancy version when pdsch-
AggregationFactor is present

| rv_{id} indicated | | | | |
|---|---|---|---|---|
| by the DCI | | | | |
| scheduling | rv_{id} to be applied to n^{th} transmission occasion | | | |
| the PDSCH | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

In NR Rel-16, proposals for indicating the number of repetitions in DCI are being currently discussed. Some proposals in NR Rel-16 include indicating the number of repetitions in a newly introduced DCI field. Some other proposals in NR Rel-16 include indicating the number of repetitions using an existing DCI field such as Time Domain Resource Allocation (TDRA) field.

NR Rel-16 Enhancements for PDSCH with multi-TRPs. In NR Rel-16, there are discussions ongoing on the support of PDSCH with multi-TRP. One mechanism that is being considered in NR Rel-16 is a single PDCCH scheduling one or multiple PDSCH from different TRPs. The single PDCCH is received from one of the TRPs. FIG. 3B illustrates an example of a NR Rel-16 Enhancement for PDSCH where multiple PDSCHs corresponding to different TCI states are received from multi-TRPs. FIG. 3B shows an example where a DCI received by the UE in PDCCH from TRP1 schedules two PDSCHs. The first PDSCH (PDSCH1) is received from TRP1 and the second PDSCH (PDSCH2) is received from TRP2. Alternatively, the single PDCCH schedules a single PDSCH where PDSCH layers are grouped into two groups and where layer group 1 is received from TRP1 and layer group 2 is received from TRP2. In such cases, each PDSCH or layer group is transmitted from a different TRP has a different TCI state associated with it. In the example of FIG. 3B, PDSCH1 is associated with TCI State p, and PDSCH 2 is associated with TCI state q.

In the RANI. AdHoc meeting in January 2019, the following was agreed: TCI indication framework shall be enhanced in Rel-16 at least for eMBB. Each TCI code point in a DCI can correspond to one or two TCI states. When two TCI states are activated within a TCI code point, each TCI state corresponds to one CDM group, at least for DMRS type 1. FFS design for DMRS type 2. FFS: TCI field in DCI, and associated MAC-CE signaling impact.

According to the above agreement, each codepoint in the DCI Transmission Configuration Indication field can be mapped to either one or two TCI states. This can be interpreted as follows:

“A DCI in PDCCH schedules one or two PDSCHs (or one or two layer groups if a single PDSCH) where each PDSCH or layer group is associated with a different TCI state; the codepoint of the Transmission Configuration Indication field in DCI indicates the 1-2 TCI states associated with the one or two PDSCHs or layer groups scheduled.” If two TCI states are indicated, the DMRS ports for the two PDSCHs or the two layer groups respectively are not mapped to the same DMRS CDM group.

It should be noted that in FR2 operation, a single PDCCH that is received by a UE using one TCI state with QCL type D (for example, single PDCCH received using one received beam) may indicate one or more PDSCHs associated with another TCI state with QCL type D (for example, one of the PDSCHs received using another received beam). In this case, the UE needs to switch beams from the point of receiving the last symbol of the single PDCCH to the point of receiving the first symbol of the PDSCH. Such beam switching delays are counted in terms of number of OFDM symbols. For example, at 60 kHz subcarrier spacing, the beam switching delay can be up to 7 symbols; at 120 kHz subcarrier spacing, the beam switching delay can be up to 14 symbols.

Multi-TRP based PDSCH transmission different schemes are being considered in NR Rel-16. One of the schemes involves slot-based time multiplexing the different PDSCHs transmitted from multiple TRPs. An example is shown in FIG. 4. In this example, a PDCCH indicates two different PDSCHs where PDSCH 1 associated with TCI state p is transmitted from TRP1 and PDSCH 2 associated with TCI state q is transmitted from TRP2. Since PDSCHs 1 and 2 are time multiplexed in different slots, the DMRS corresponding to the two PDSCHs are transmitted in non-overlapping resources (i.e., different slots). Hence, the DMRSs for the two PDSCHs can use the same or different CDM group or even exactly the same antenna ports in each of the slots. In the example of FIG. 4, DMRS for PDSCH 1 is transmitted using CDM group 0 in slot n, while DMRS for PDSCH 2 is transmitted using CDM group 0 in slot n+1. NR Rel-16, the scheme of slot-based time-multiplexed PDSCHs associated with different TCI states is useful for URLLC.

Another scheme involves mini-slot-based time multiplexing (also known as PDSCH Type B scheduling in NR specifications) the different PDSCHs transmitted from multiple TRPs. FIG. 5 illustrates an example of an NR Rel-16 mini-slot-based time-multiplexed PDSCHs from two TRPs where each PDSCH is associated with a different TCI state. An example is shown in FIG. 5. In this example, a PDCCH indicates two different PDSCHs where PDSCH 1 associated with TCI state p is transmitted from TRP 1 and PDSCH 2 associated with TCI state q is transmitted from TRP2. Since PDSCHs 1 and 2 are time multiplexed in different mini-slots, the DMRS corresponding to the two PDSCHs are transmitted in non-overlapping resources (i.e., different mini-slots). Hence, the DMRSs for the two PDSCHs can use the same or different CDM group or even the same antenna ports in each mini-slot. In the example of FIG. 5, DMRS for PDSCH 1 is transmitted using CDM group 0 in mini-slot n, while DMRS for PDSCH 2 is transmitted using CDM group 0 in mini-slot n+1. In NR Rel-16, the scheme of mini-slot-based time-multiplexed PDSCHs associated with different TCI states is being considered for URLLC.

In NR downlink, the PDSCH can be scheduled with either dynamic assignments or DL SPS. In case of dynamic assignments, the gNB provides a DL assignment to the UE for each DL transmission (i.e., PDSCH). In case of DL SPS, the transmission parameters are partly RRC configured and partly L1 signaled via DCI during the SPS activation. That is, some of the transmission parameters are semi-statically configured via RRC, and the remaining transmission parameters are provided by a DCI which activates the DL SPS process signaling which also provides. The scheduling release (also called deactivation) of the DL SPS process is also signaled by the gNB via a DCI.

In Rel-15, the SPS-Config IE is used to configure downlink semi-persistent transmission by RRC. As can be seen, the periodicity of the transmission, the number of HARQ processes and the PUCCH resource identifier as well as the possibility to configure an alternative MCS table can be configured by RRC signaling. Downlink SPS may be configured on the SpCell as well as on SCells. But it shall not be configured for more than one serving cell of a cell group at once.

### SPS-Config Information Element

-- ASN1START
-- TAG-SPS-CONFIG-START

| | |
|---|---|
| SPS-Config : := | SEQUENCE { |
| periodicity | ENUMERATED {ms10, ms20, |

ms32, ms40, ms64, ms80, ms128, ms160, ms320, ms640,

spare6,

spare5, spare4, spare3, spare2, spare1},

| | |
|---|---|
| nrofHARQ-Processes | INTEGER (1. .8), |
| n1PUCCH-AN | PUCCH-ResourceId |
| OPTIONAL, -- Need M | |
| mcs-Table | ENUMERATED {qam64LowSE} |
| OPTIONAL, -- Need S | |
| . . . | |
| } | |
| -- TAG-SPS-CONFIG-STOP | |
| -- ASN1STOP | |

In Rel-16, for Industrial Internet of Things (IIoT) support, it has been agreed that multiple DL SPS configurations can be simultaneously active on a bandwidth part (BWP) of a serving cell. Separate activation, as well as separate release, for different DL SPS configurations are to be supported for a given BWP of a serving cell. The motivation is, for example, that different IIoT services may have different periodicity and potentially need different MCS tables.

There currently exist certain challenge(s). Configuring multi-TRP reliability scheme related information in the PDSCH-Config is unsuitable for the case when multiple DL SPS configurations can be simultaneously active since such configuration would then automatically apply to all DL SPS configurations which is very inflexible and a problem. As such, improved systems and methods are needed.

### SUMMARY

Systems and methods for multi-Transmission Reception Point (TRP) transmission for downlink Semi-Persistent Scheduling (SPS) are provided. In some embodiments, a method performed by a wireless device for configuring one or more wireless communications settings includes determining a plurality of wireless communications configurations; and simultaneously activating at least two of the plurality of wireless communications configurations such that the at least two of the plurality of wireless communications configurations include configuration of one or more of a low latency and/or reliability scheme and one or more properties related to the low latency and/or reliability scheme. This enables multi-TRP based reliability scheme for the case when multiple downlink SPS configurations can be simultaneously activated. By independently configuring low latency and/or reliability schemes and properties of such schemes to different downlink SPS configurations, different reliability and/or low latency schemes can be flexibly applied to different downlink SPS configurations that may be associated with different traffic profiles.

Certain aspects of the present disclosure and their embodiments may provide solutions to the aforementioned or other challenges. The proposed solution provides a method of configuring a wireless device with a plurality of downlink SPS configurations that can be activated simultaneously wherein the plurality of SPS configurations have independent configuration of one or more of the following:

a. Independent configuration of low latency and/or reliability schemes which are applicable when multiple TCI states are indicated to the wireless device

b. One or more properties related to low latency and/or reliability schemes which are applicable when multiple TCI states are indicated to the wireless device.

There are, proposed herein, various embodiments which address one or more of the issues disclosed herein.

In some embodiments, a method performed by a base station for configuring one or more wireless communications settings, the method comprising one or more of the following: communicating with a wireless device such that a plurality of wireless communications configurations are configured for the wireless device; and communicating with the wireless device such that at least two of the plurality of wireless communications configurations are simultaneously activated and the at least two of the plurality of wireless communications configurations include configuration of one or more of a low latency and/or reliability scheme and one or more properties related to the low latency and/or reliability scheme.

In some embodiments, communicating with the wireless device such that at least two of the plurality of wireless communications configurations are simultaneously activated and the at least two of the plurality of wireless communications configurations include configuration of one or more of the low latency and/or reliability scheme and the one or more properties related to the low latency and/or reliability scheme is performed only when the wireless device is simultaneously communicating with at least two transmission points.

In some embodiments, communicating with the wireless device such that at least two of the plurality of wireless communications configurations are simultaneously activated and the at least two of the plurality of wireless communications configurations include configuration of one or more of the low latency and/or reliability scheme and the one or more properties related to the low latency and/or reliability scheme comprises sending an activating DCI to the wireless device. In some embodiments, the wireless communications configurations are semi-persistent scheduling (SPS) configurations. In some embodiments, communicating with the wireless device such that the plurality of wireless communications configurations are configured for the wireless device is performed via Radio Resource Control (RRC) signaling. In some embodiments, the low latency scheme and the reliability scheme include one or more of spatial multiplexing, frequency multiplexing, slot-based time multiplexing, and mini-slot based time multiplexing. In some embodiments, the one or more properties related to the low latency scheme and the one or more properties related to the reliability scheme include one or more of an repetition factor for slot based time repetition, a frequency domain resource allocation information for frequency repetition, a time domain resource allocation information for time repetition, and a configuration of additional TCI states in addition to what is indicated in the activating DCI.

In some embodiments, a method of configuring a wireless device with plurality of downlink semi-persistent scheduling (SPS) configurations that can be activated simultaneously wherein the plurality of SPS configurations have independent configuration of one or more of the following: independent configuration of low latency and/or reliability schemes which are applicable when multiple TCI states are indicated to the wireless device; and one or more properties related to low latency and/or reliability schemes which are applicable when multiple TCI states are indicated to the wireless device.

In some embodiments, the plurality of downlink SPS are RRC configured. In some embodiments, the simultaneous activation of the plurality of downlink SPS configurations is done via an activating DCI. In some embodiments, the multiple TCI states are indicated to the wireless device by the activating DCI. In some embodiments, the indication of multiple TCI states corresponds to reception of downlink SPS from multiple TRPs or multiple panels.

In some embodiments, if multiple TCI states are not indicated (i.e., a single TCI state is indicated) when activating a given downlink SPS configuration, then the reliability schemes or the properties of the reliability schemes is not configured for the given downlink SPS configuration. In some embodiments, if multiple TCI states are not indicated (i.e., a single TCI state is indicated) when activating a given downlink SPS configuration, then the reliability schemes or the properties of the reliability schemes which may be configured for the given downlink SPS configuration are not utilized (i.e., ignored) by the wireless device.

In some embodiments, the low latency and/or reliability schemes can be any one or a combination of spatial multiplexing, frequency multiplexing, slot-based time multiplexing, mini-slot based time multiplexing. In some embodiments, the one or more properties related to low latency and/or reliability schemes may include the configuration of an repetition factor for slot based time repetition, a frequency domain resource allocation information for frequency repetition, a time domain resource allocation information for time repetition, or a configuration of additional TCI states in addition to what is indicated in the activating DCI. In some embodiments, the transmission configuration indication field in the activating/deactivating DCI is used to differentiate which DL SPS configuration is to be activated/deactivated. In some embodiments, the order of TCI states indicated by the codepoint of the transmission configuration indication field may be changed by resending the activating DCI in order to associated different TCI states with different RVs.

Certain embodiments may provide one or more of the following technical advantage(s). The proposed solution enables multi-TRP based reliability scheme for the case when multiple DL SPS configurations can be simultaneously activated. By independently configuring low latency and/or reliability schemes and properties of such schemes to different DL SPS configurations, different reliability and/or low latency schemes can be flexibly applied to different DL SPS configurations that may be associated with different traffic profiles.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates typical data scheduling in New Radio (NR) on a per slot basis;

FIG. 2 illustrates basic NR physical time-frequency resource grid;

FIG. 3A illustrates the mapping of front-loaded Demodulation Reference Signal (DMRS) for configuration type 1 and type 2;

FIG. 3B illustrates an example of a NR Rel-16 Enhancement for Physical Downlink Shared Channel (PDSCH) where multiple PDSCHs corresponding to different Transmission Configuration Indicator (TCI) states are received from multi-TRPs;

FIG. 4 illustrates an example where a PDCCH indicates two different PDSCHs where PDSCH 1 associated with TCI state p is transmitted from Transmission Reception Point (TRP) 1 and PDSCH 2 associated with TCI state q is transmitted from TRP2;

FIG. 5 illustrates an example of an NR Rel-16 mini-slot-based time-multiplexed PDSCHs from two TRPs where each PDSCH is associated with a different TCI state;

FIG. 6 illustrates one example of a cellular communications network, according to some embodiments of the present disclosure;

FIG. 7 illustrates a wireless communication system represented as a Fifth Generation (5G) network architecture composed of core Network Functions (NFs), according to some embodiments of the present disclosure;

FIG. 8 illustrates a 5G network architecture using service-based interfaces between the NFs in the control plane, instead of the point-to-point reference points/interfaces used in the 5G network architecture of FIG. 7, according to some embodiments of the present disclosure;

FIG. 9 is a flow chart illustrating a method performed by a wireless device for configuring one or more wireless communications settings, according to some embodiments of the present disclosure;

FIG. 10 is a flow chart illustrating a method performed by a base station for configuring one or more wireless communications settings, according to some embodiments of the present disclosure;

FIG. 11 illustrates an example of changing Redundancy Version (RV) to TRP association by changing the TRP order in the TCI field of a Downlink Control Information (DCI) for Semi-Persistent Scheduling (SPS) reactivation, according to some embodiments of the present disclosure;

FIG. 12 illustrates an example of PDSCH repetition from a TRP over consecutive slots, according to some embodiments of the present disclosure;

FIG. 13 is a schematic block diagram of a radio access node according to some embodiments of the present disclosure;

FIG. 14 is a schematic block diagram that illustrates a virtualized embodiment of the radio access node according to some embodiments of the present disclosure;

FIG. 15 is a schematic block diagram of the radio access node according to some other embodiments of the present disclosure;

FIG. 16 is a schematic block diagram of a wireless communication device according to some embodiments of the present disclosure;

FIG. 17 is a schematic block diagram of the wireless communication device according to some other embodiments of the present disclosure;

FIG. 18 illustrates a communication system which includes a telecommunication network, such as a Third Generation Partnership Project (3GPP)-type cellular network, which comprises an access network, such as a Radio Access Network (RAN), and a core network, according to some embodiments of the present disclosure;

FIG. 19 illustrates a communication system, a host computer comprises hardware including a communication interface configured to set up and maintain a wired or wireless connection with an interface of a different communication device of the communication system, according to some embodiments of the present disclosure;

FIGS. 20-23 are flowcharts illustrating methods implemented in a communication system, according to some embodiments of the present disclosure.

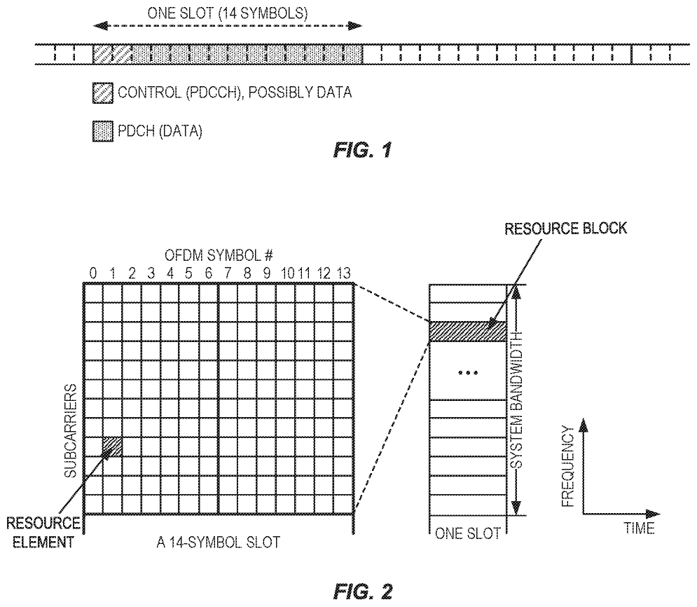

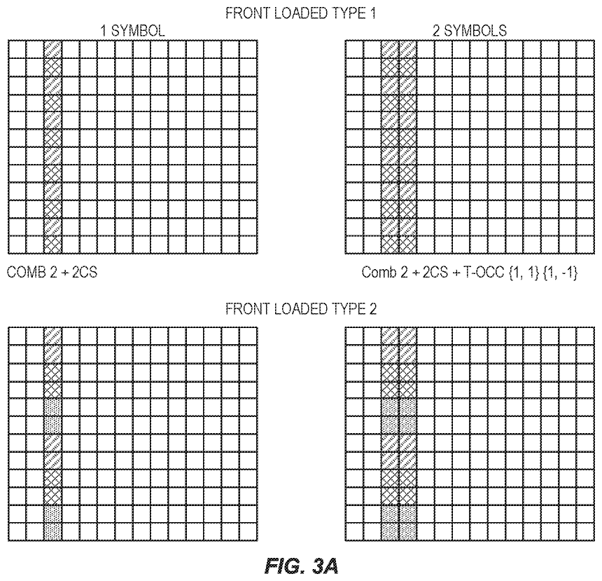

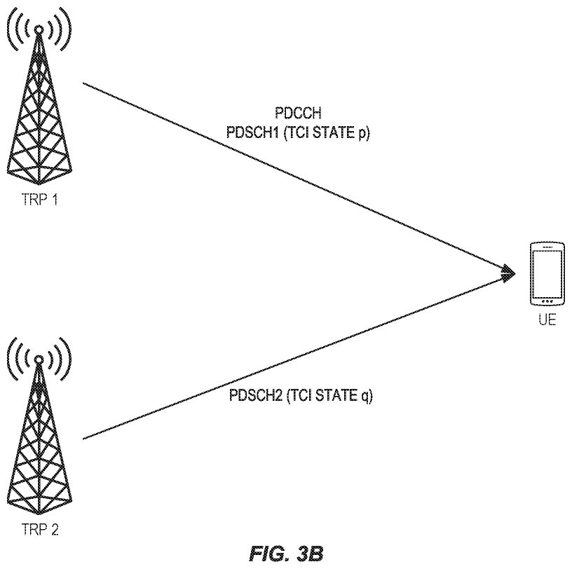

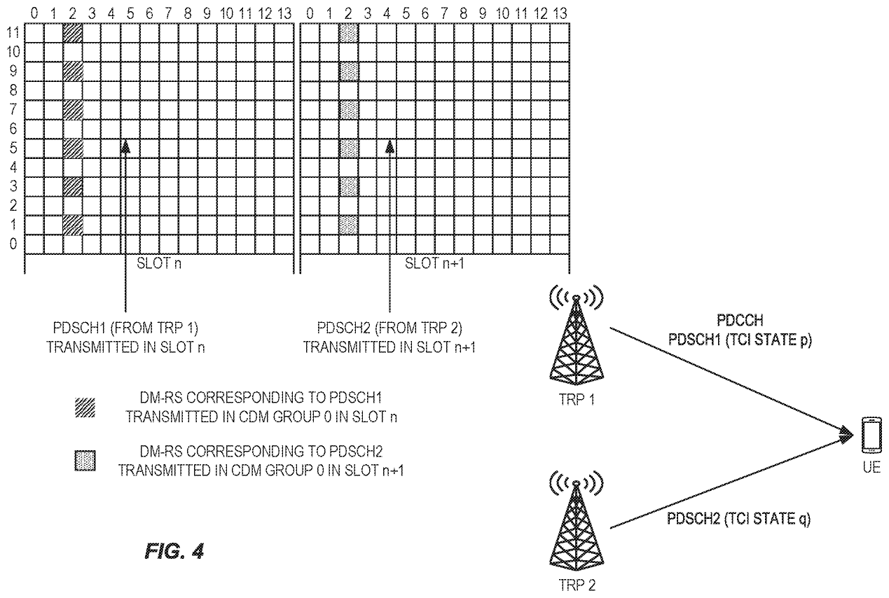

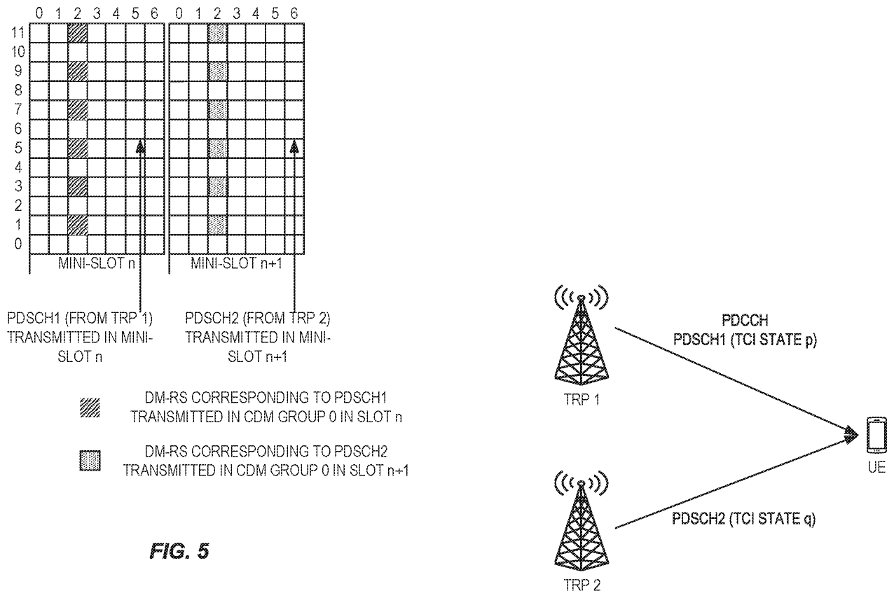

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (P-GW), a Service Capability Exposure Function (SCEF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

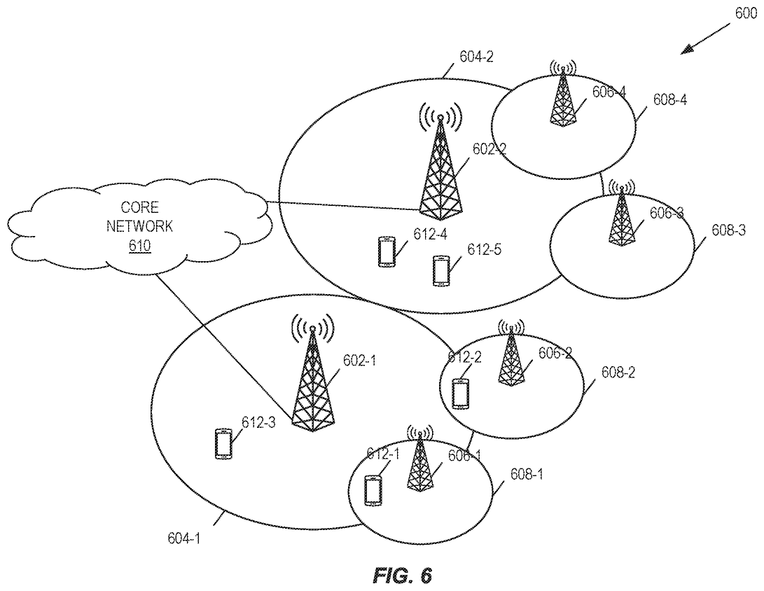

FIG. 6 illustrates one example of a cellular communications network 600 according to some embodiments of the present disclosure. In the embodiments described herein, the cellular communications network 600 is a 5G NR network. In this example, the cellular communications network 600 includes base stations 602-1 and 602-2, which in LTE are referred to as eNBs and in 5G NR are referred to as gNBs, controlling corresponding macro cells 604-1 and 604-2. The base stations 602-1 and 602-2 are generally referred to herein collectively as base stations 602 and individually as base station 602. Likewise, the macro cells 604-1 and 604-2 are generally referred to herein collectively as macro cells 604 and individually as macro cell 604. The cellular communications network 600 may also include a number of low power nodes 606-1 through 606-4 controlling corresponding small cells 608-1 through 608-4. The low power nodes 606-1 through 606-4 can be small base stations (such as pico or femto base stations) or Remote Radio Heads (RRHs), or the like. Notably, while not illustrated, one or more of the small cells 608-1 through 608-4 may alternatively be provided by the base stations 602. The low power nodes 606-1 through 606-4 are generally referred to herein collectively as low power nodes 606 and individually as low power node 606. Likewise, the small cells 608-1 through 608-4 are generally referred to herein collectively as small cells 608 and individually as small cell 608. The base stations 602 (and optionally the low power nodes 606) are connected to a core network 610.

The base stations 602 and the low power nodes 606 provide service to wireless devices 612-1 through 612-5 in the corresponding cells 604 and 608. The wireless devices 612-1 through 612-5 are generally referred to herein collectively as wireless devices 612 and individually as wireless device 612. The wireless devices 612 are also sometimes referred to herein as UEs.

FIG. 7 illustrates a wireless communication system represented as a 5G network architecture composed of core Network Functions (NFs), where interaction between any two NFs is represented by a point-to-point reference point/interface. FIG. 7 can be viewed as one particular implementation of the system 600 of FIG. 6.

Seen from the access side the 5G network architecture shown in FIG. 7 comprises a plurality of User Equipment (UEs) connected to either a Radio Access Network (RAN) or an Access Network (AN) as well as an Access and Mobility Management Function (AMF). Typically, the R(AN) comprises base stations, e.g., such as evolved Node Bs (eNBs) or 5G base stations (gNBs) or similar. Seen from the core network side, the 5G core NFs shown in FIG. 7 include a Network Slice Selection Function (NSSF), an Authentication Server Function (AUSF), a Unified Data Management (UDM), an AMF, a Session Management Function (SMF), a Policy Control Function (PCF), and an Application Function (AF).

Reference point representations of the 5G network architecture are used to develop detailed call flows in the normative standardization. The N1 reference point is defined to carry signaling between the UE and AMF. The reference points for connecting between the AN and AMF and between the AN and User Plane Function (UPF) are defined as N2 and N3, respectively. There is a reference point, N11, between the AMF and SMF, which implies that the SMF is at least partly controlled by the AMF. N4 is used by the SMF and UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since the PCF applies policy to the AMF and SMP, respectively. N12 is required for the AMF to perform authentication of the UE. N8 and N10 are defined because the subscription data of the UE is required for the AMF and SMF.

The 5G core network aims at separating user plane and control plane. The user plane carries user traffic while the control plane carries signaling in the network. In FIG. 7, the UPF is in the user plane and all other NFs, i.e., the AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like the PCF and AUSF can be separated as shown in FIG. 7. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

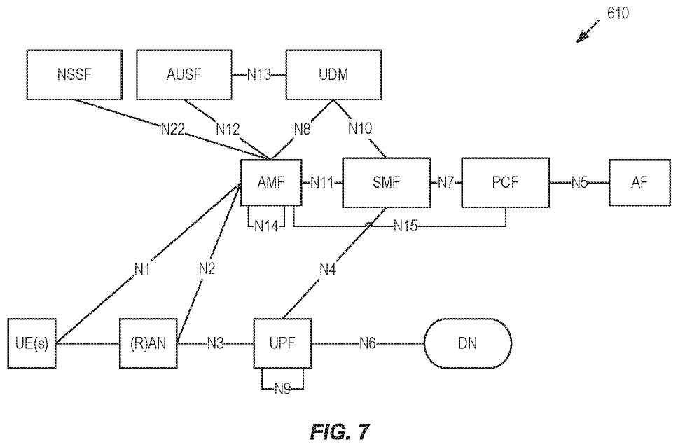

FIG. 8 illustrates a 5G network architecture using service-based interfaces between the NFs in the control plane, instead of the point-to-point reference points/interfaces used in the 5G network architecture of FIG. 7. However, the NFs described above with reference to FIG. 7 correspond to the NFs shown in FIG. 8. The service(s) etc. that a NF provides to other authorized NFs can be exposed to the authorized NFs through the service-based interface. In FIG. 8 the service based interfaces are indicated by the letter “N” followed by the name of the NF, e.g., Namf for the service based interface of the AMF and Nsmf for the service based interface of the SMF etc. The Network Exposure Function (NEF) and the Network Repository Function (NRF) in FIG. 8 are not shown in FIG. 7 discussed above. However, it should be clarified that all NFs depicted in FIG. 7 can interact with the NEF and the NRF of FIG. 8 as necessary, though not explicitly indicated in FIG. 7.

Some properties of the NFs shown in FIGS. 7 and 8 may be described in the following manner. The AMF provides UE-based authentication, authorization, mobility management, etc. A UE even using multiple access technologies is basically connected to a single AMF because the AMF is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF provides information on the packet flow to the PCF responsible for policy control in order to support Quality of Service (QoS). Based on the information, the PCF determines policies about mobility and session management to make the AMF and SMF operate properly. The AUSF supports authentication function for UEs or similar and thus stores data for authentication of UEs or similar while the UDM stores subscription data of the UE. The Data Network (DN), not part of the 5G core network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

Configuring multi-TRP reliability scheme related information in the PDSCH-Config is unsuitable for the case when multiple DL SPS configurations can be simultaneously active since such configuration would then automatically apply to all DL SPS configurations which is very inflexible and a problem. Hence, it is an open problem how to configure multi-TRP reliability scheme related information for the case when multiple DL SPS configurations can be simultaneously active.

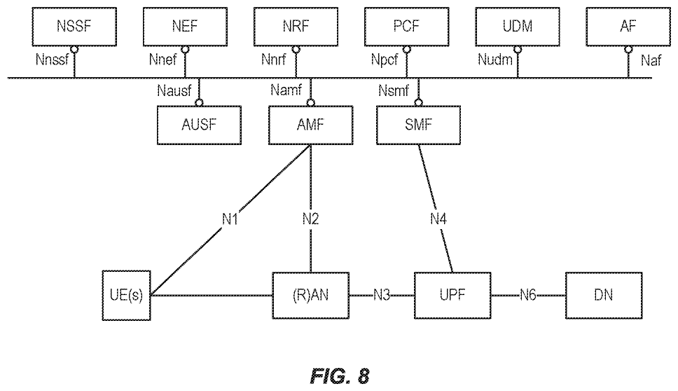

Systems and methods for multi-Transmission Reception Point (TRP) transmission for downlink Semi-Persistent Scheduling (SPS) are provided. FIG. 9 illustrates a method performed by a wireless device for configuring one or more wireless communications settings. In some embodiments, the wireless device determines a plurality of wireless communications configurations (step 900). Then the wireless device simultaneously activates at least two of the plurality of wireless communications configurations such that the at least two of the plurality of wireless communications configurations include configuration of one or more of a low latency and/or reliability scheme and one or more properties related to the low latency and/or reliability scheme (step 902). This enables a multi-TRP based reliability scheme for the case when multiple downlink SPS configurations can be simultaneously activated. By independently configuring low latency and/or reliability schemes and properties of such schemes to different downlink SPS configurations, different reliability and/or low latency schemes can be flexibly applied to different downlink SPS configurations that may be associated with different traffic profiles.

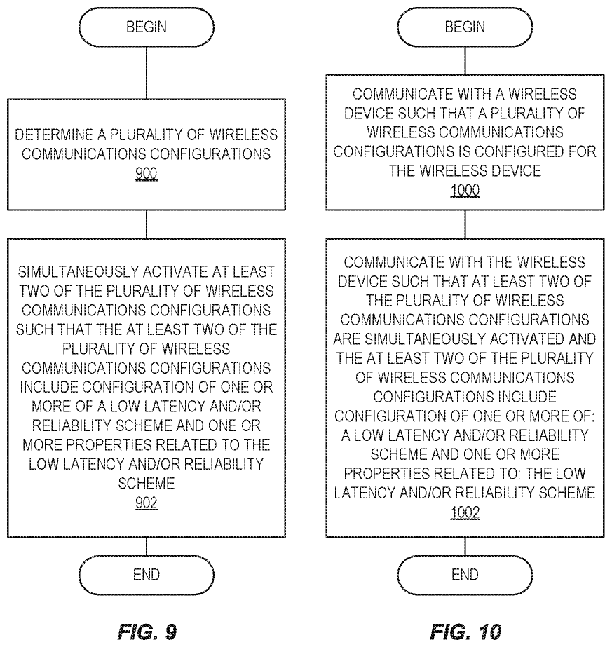

FIG. 10 illustrates a method performed by a base station for configuring one or more wireless communications settings. In some embodiments, a base station communicates with a wireless device such that a plurality of wireless communications configurations is configured for the wireless device (step 1000). The base station then communicates with the wireless device such that at least two of the plurality of wireless communications configurations are simultaneously activated and the at least two of the plurality of wireless communications configurations include configuration of one or more of: a low latency and/or reliability scheme and one or more properties related to: the low latency and/or reliability scheme (step 1002). This enables multi-TRP based reliability scheme for the case when multiple downlink SPS configurations can be simultaneously activated. By independently configuring low latency and/or reliability schemes and properties of such schemes to different downlink SPS configurations, different reliability and/or low latency schemes can be flexibly applied to different downlink SPS configurations that may be associated with different traffic profiles.

Certain aspects of the present disclosure and their embodiments may provide solutions to the aforementioned or other challenges. The proposed solution provides a method of configuring a wireless device with a plurality of downlink SPS configurations that can be activated simultaneously wherein the plurality of SPS configurations have independent configuration of one or more of the following: a. Independent configuration of low latency and/or reliability schemes which are applicable when multiple Transmission Configuration Indicator (TCI) states are indicated to the wireless device; b. One or more properties related to low latency and/or reliability schemes which are applicable when multiple TCI states are indicated to the wireless device.

It should be noted that the possibility to have multiple SPS configurations to be simultaneously active for a given BWP of a serving cell is to be able to support different traffic types/characteristics simultaneously. Here, each active SPS configuration may correspond to a different traffic type/characteristic. Hence, the inventors have observed a need to tailor the different DL SPS configurations to possibly be configured with different multi-TRP reliability schemes that are suitable depending on the traffic type/characteristic.

It should be noted that having multiple SPS configurations that are simultaneously active for a given BWP of a serving enables support for different traffic types/characteristics simultaneously. Here, each active SPS configuration may correspond to a different traffic type/characteristic. Hence, there is a need to tailor the different DL SPS configurations to possibly be configured with different multi-TRP reliability schemes that are suitable depending on the traffic type/characteristic.

A straightforward solution would be to configure multi-TRP reliability scheme related information in the PDSCH-Config. However, this is unsuitable since such configuration would then apply to all DL SPS configurations with no differentiation. The core of the present disclosure is that different DL SPS configurations can have independent configuration of the use of multi-TRP reliability scheme, including that some DL SPS configurations don't utilize multi-TRP transmission and reception at all. We provide several embodiments addressing how to tailor a suitable multi-TRP reliability scheme specific to a DL SPS configuration.

Embodiment 1: In a first embodiment, the multi-TRP reliability scheme is configured as part of the DL SPS configuration. A higher layer parameter can be introduced in the DL SPS configuration that configures the use of multi-TRP operation. This parameter can be optionally present, and if absent, then no multi-TRP operation need to be considered for this DL SPS configuration. If present, the parameter may take one of a set of different values that characterizes the scheme of multi-TRP transmissions for reliability. For example, the list of values could be the four different modes of spatial multiplexing, frequency multiplexing, slot-based time multiplexing, mini-slot based time multiplexing.

For example, if a DL SPS configuration contains a higher layer parameter with value set to frequency multiplexing, then the frequency multiplexing based multi-TRP reliability scheme is applicable when this DL SPS configuration is activated.

In some variants of this embodiment, the multi-TRP reliability scheme which is configured in the DL SPS configuration only applies when the codepoint of the Transmission Configuration Indication field in the DCI activating the DL SPS configuration indicates more than one TCI state. If the codepoint only indicates a single TCI state, then a single TRP transmission should be assumed by the UE, and if the DL SPS configuration contains a higher layer parameter indicating a reliability scheme, then that configuration should be ignored for the activated DL SPS configuration.

In another variant of the first embodiment, the higher layer configuration introduced in the DL SPS configuration may indicate a combination of more than one multi-TRP reliability scheme. Such a combination may include one of the following:
A combination of spatially multiplexed and frequency multiplexed scheme.
A combination of frequency multiplexed and slot-based time multiplexed scheme.
A combination of frequency multiplexed and mini-slot based time multiplexed scheme.
A combination of spatially multiplexed and slot-based or mini-slot based multiplexed scheme

The above list is non-limiting, and the higher layer configuration introduced in the DL SPS configuration may indicate a combination that is not listed above.

Hence, the values signaled when configuring DL SPS indicate the combinations of reliability schemes also including allowed combinations, for example, frequency-and-slot-based time multiplexing.

Embodiment 2: In this embodiment, an indication of which multi-TRP reliability scheme should be attributed to a given DL SPS configuration is implicitly given by additional higher layer parameters configured in the given DL SPS configuration.

A first example is configuring a pdsch-AggregationFactor as part of the DL SPS configuration by higher layers. In this case, a UE may be configured with a pdsch-AggregationFactor of 2 in one DL SPS configuration and an pdsch-AggregationFactor of 4 in another DL SPS configuration. Hence, slot based time-multiplexing schemes with a different number of repetitions (i.e., different A pdsch-ggregationFactors) can be configured to different DL SPS configurations depending on the reliability requirements. One example of providing pdsch-AggregationFactor in SPS-Config is illustrated below, where the possible number of repetitions to configure is: 2, 4, 8, and 16.

### SPS-Config Information Element

-- ASN1START
-- TAG-SPS-CONFIG-START

| | |
|---|---|
| SPS-Config : := | SEQUENCE { |
| periodicity | ENUMERATED {ms10, ms20, |

ms32, ms40, ms64, ms80, ms128, ms160, ms320, ms640,

spare6,

spare5, spare4, spare3, spare2, spare1},

| | |
|---|---|
| pdsch-AggregationFactor | ENUMERATED { n2, n4, n8, |
| n16 } | OPTIONAL, -- Need |
| S | |
| nrofHARQ-Processes | INTEGER (1. .8), |
| n1PUCCH-AN | PUCCH-ResourceId |
| OPTIONAL, -- Need M | |
| mcs-Table | ENUMERATED {qam64LowSE} |
| OPTIONAL, -- Need S | |
| . . . | |
| } | |
| -- TAG-SPS-CONFIG-STOP | |
| -- ASN1STOP | |

A second example is configuring frequency domain resource allocation information as part of the DL SPS configuration to support frequency multiplexing scheme. In one variant of the embodiment, the PRBs for the PDSCH from a first TRP (corresponding to a first TCI state indicated in the activating DCI) can be provided by the frequency domain resource allocation field of the activating DCI; the location of the PRBs for the PDSCH from a second TRP (corresponding to a second TCI state indicated in the activating DCI) can be provided as an offset as part of the DL SPS configuration. That is, if the activating DCI indicates PRBs {i, i+1, . . . , i+K} for the PDSCH from TRP1, then an offset ΔK configured in the DL SPS configuration provides the PRBs for the PDSCH from TRP2 as {i+ΔK, i+ΔK+1, . . . , i+ΔK+K}. It should be noted that the number of frequency domain allocations can also be provided as part of each DL SPS configuration by configuring one or more ΔK values where each ΔK value provides the PRB offset for a different TRP.

Alternatively, in another embodiment, the RBs for the PDSCH from all TRPs are provided by the frequency domain resource allocation field of the activating DCI. The RBs are interleaved among the TRPs, starting from the first TRP, in a granularity that can be either configured by higher layer or specified, such as number of RBs.

A third example is configuring time domain resource allocation information as part of the DL SPS configuration to support mini-slot based time multiplexing scheme. Specifically, a list of time domain resource allocations can be configured as part of the DL SPS configuration where each time domain resource allocation may provide the PDSCH mapping type (i.e., type A/slot-based or type B/mini-slot-based), start symbol and symbol duration of PDSCH, and the slot offset for HARQ-ACK-NACK feedback. By making the list of time domain resource allocations specific to DL SPS configuration, a suitable set of time domain resource allocations can be configured per DL SPS and the activating DCI can select one of the configured time domain resource allocations.

A fourth example is configuring additional TCI states per DL SPS configuration. As per current agreements in rel-16, the transmission configuration indication field can indicate either 1 or two TCI states. Hence, if additional reliability is desired via using more than 2 TRPs (i.e., more than two TCI states), then these additional TCI states can be configured as part of DL SPS configuration.

Embodiment 3: In this embodiment, the transmission configuration indication field in the activating/deactivating DCI is used to differentiate which DL SPS configuration is to be activated. The number of TCI states can be configured as part of DL SPS configuration. Then,
if the activation DCI indicates 1 TCI state in its transmission configuration indication field, then one of the DL SPS configurations with 1 TCI state configured is activated,
if the activation DCI indicates 2 TCI state in its transmission configuration indication field, then one of the DL SPS configurations with 2 TCI state configured is activated,
if the activation DCI indicates 4 TCI state in its transmission configuration indication field, then one of the DL SPS configurations with 4 TCI state configured is activated.

If multiple SPS configurations are configured with N TCI states, then which SPS configuration among these multiple SPS configurations is activated may be dependent on other fields in the activation DCI.

For release (i.e., deactivation) DCI, the TCI state is not needed. Hence the TCI field can be used as a special field for DL SPS release PDCCH validation. For example, if a DCI format containing TCI field is used as release DCI, then the TCI field can be set to a predefined value for validation of the release DCI. The predefined value can be all “1”s.

Embodiment 4: For DL SPS, the RV field of a DCI in activating a DL SPS is set to all “0”s for validation purpose. Therefore, when slot aggregation is configured, a fixed RV sequence of (0, 2, 3, 1) is applied over consecutive slots according to Table 5.1.2.1-2. Note that a PDSCH with RV=0 contains all the systematic bits of a codeword and is self-decodable in general, while a PDSCH with RV=2 or 1 does not contain the systematic bits and is not self-decodable in general, and typically needs to be combined and PDSCH with RV=0 to decode. This fixed RV sequence is not an issue for single TRP transmission as the PDSCHs are transmitted over the same channel between a TRP and a UE and the UE can combine the PDSCHs to achieve more reliable decoding of a TB. When multiple TRPs are deployed and a TB is also repeated over TRPs, this fixed RV sequence is not desirable. This is because the channels of TRPs to a UE can be different, and if PDSCH with RV=0 is transmitted over a TRP with bad channel, it could degrade the overall decoding performance. Therefore, it is desirable to transmit PDSCH with RV=0 over a TRP with good channel if the channel condition is known at the gNB. If the channel condition is unknown to the gNB, it should allow a different RV sequence to be used in a retransmission or using different sequences at different times.

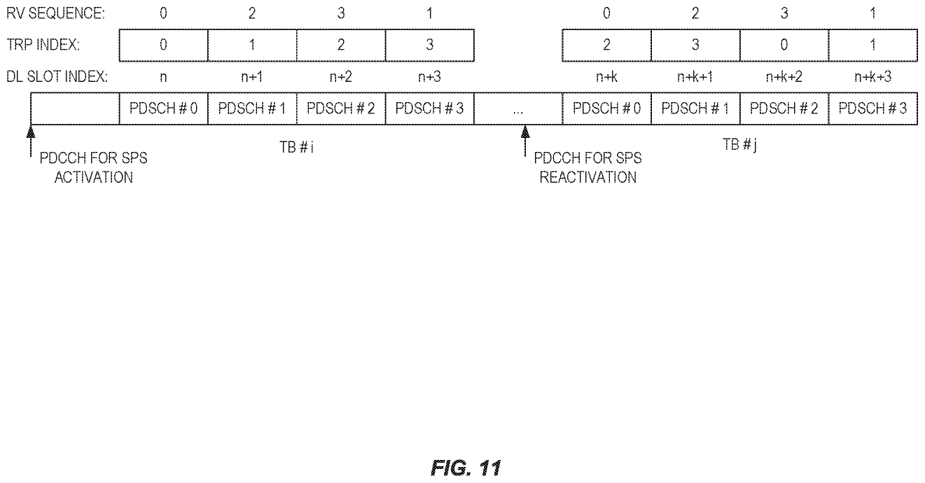

Thus, in one embodiment, the TRPs and the order of the TRPs for a SPS transmission are signaled using the TCI field of a DCI activating the SPS. The first TRP is mapped to the first RV in the sequence; the second TRP is mapped to the second RV in the RV sequence, and so on. In this way, the TRP order may be changed through a reactivation of the same SPS by sending a new DCI to the UE if the channel conditions of the TRPs have been changed. FIG. 11 illustrates an example of changing RV to TRP association by changing the TRP order in the TCI field of a DCI for SPS reactivation.

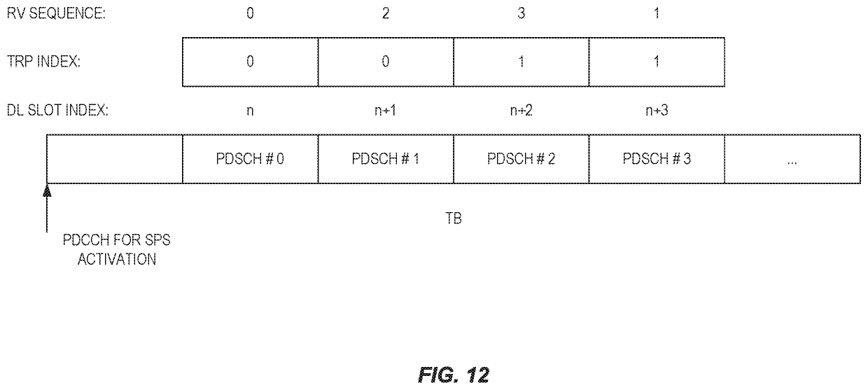

In case of mini-slot based TDM scheme and FR2, it is desirable to reduce beam switching times with a slot. For example, if there are two TRPs and 4 mini-slots, a transmission pattern of (TRP1, TRP1, TRP2, TRP2) over the four mini-slots is preferred instead of using (TRP1, TRP2, TRP1, TRP2) which needs two more beam switches. Thus, in another embodiment, a same TCI state (or TRP) may be allowed to be duplicated when indicated by the TCI field to indicate a PDSCH repetition from a TRP over more than one mini-slot. FIG. 12 illustrates an example of PDSCH repetition from a TRP over consecutive slots.

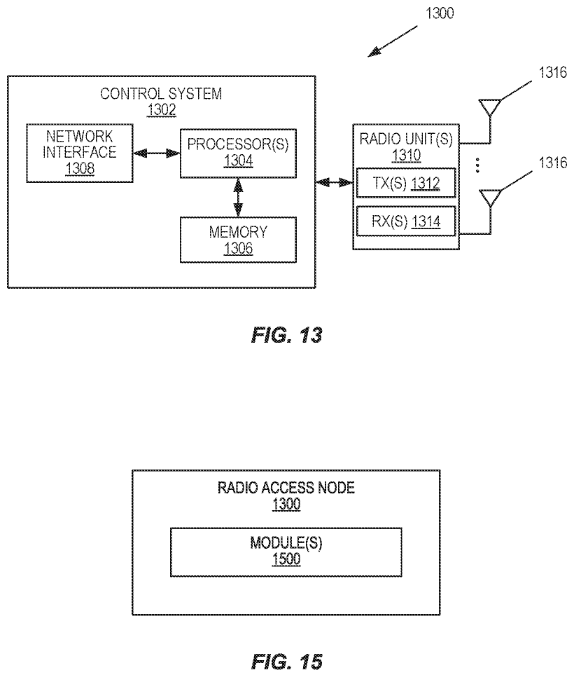

FIG. 13 is a schematic block diagram of a radio access node 1300 according to some embodiments of the present disclosure. The radio access node 1300 may be, for example, a base station 602 or 606. As illustrated, the radio access node 1300 includes a control system 1302 that includes one or more processors 1304 (e.g., Central Processing Units (CPUs), Application Specific Integrated Circuits (ASICs), Field Programmable Gate Arrays (FPGAs), and/or the like), memory 1306, and a network interface 1308. The one or more processors 1304 are also referred to herein as processing circuitry. In addition, the radio access node 1300 includes one or more radio units 1310 that each includes one or more transmitters 1312 and one or more receivers 1314 coupled to one or more antennas 1316. The radio units 1310 may be referred to or be part of radio interface circuitry. In some embodiments, the radio unit(s) 1310 is external to the control system 1302 and connected to the control system 1302 via, e.g., a wired connection (e.g., an optical cable). However, in some other embodiments, the radio unit(s) 1310 and potentially the antenna(s) 1316 are integrated together with the control system 1302. The one or more processors 1304 operate to provide one or more functions of a radio access node 1300 as described herein. In some embodiments, the function(s) are implemented in software that is stored, e.g., in the memory 1306 and executed by the one or more processors 1304.

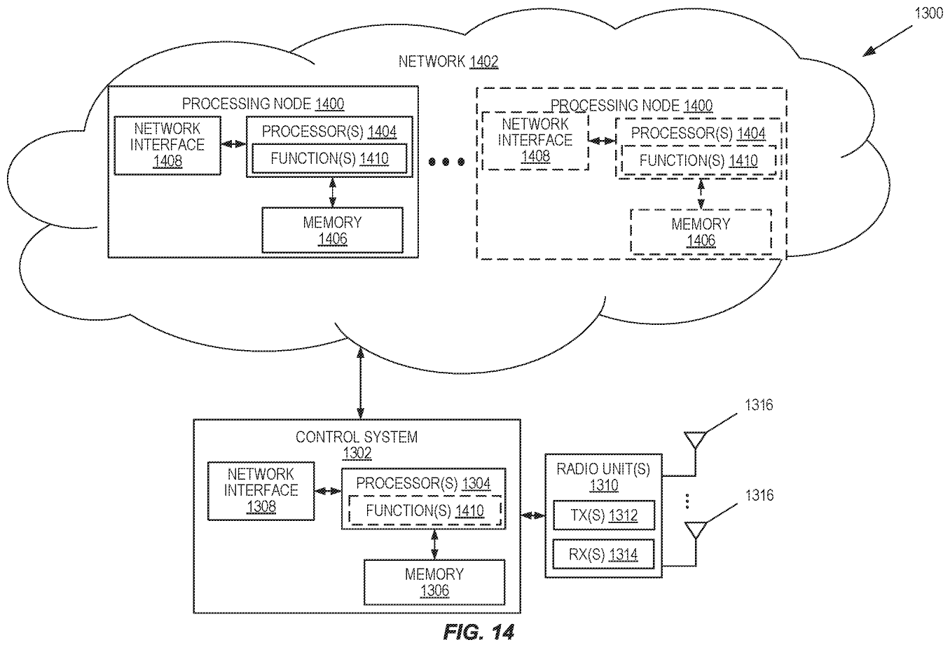

FIG. 14 is a schematic block diagram that illustrates a virtualized embodiment of the radio access node 1300 according to some embodiments of the present disclosure. This discussion is equally applicable to other types of network nodes. Further, other types of network nodes may have similar virtualized architectures.

As used herein, a “virtualized” radio access node is an implementation of the radio access node 1300 in which at least a portion of the functionality of the radio access node 1300 is implemented as a virtual component(s) (e.g., via a virtual machine(s) executing on a physical processing node(s) in a network(s)). As illustrated, in this example, the radio access node 1300 includes the control system 1302 that includes the one or more processors 1304 (e.g., CPUs, ASICs, FPGAs, and/or the like), the memory 1306, and the network interface 1308 and the one or more radio units 1310 that each includes the one or more transmitters 1312 and the one or more receivers 1314 coupled to the one or more antennas 1316, as described above. The control system 1302 is connected to the radio unit(s) 1310 via, for example, an optical cable or the like. The control system 1302 is connected to one or more processing nodes 1400 coupled to or included as part of a network(s) 1402 via the network interface 1308. Each processing node 1400 includes one or more processors 1404 (e.g., CPUs, ASICs, FPGAs, and/or the like), memory 1406, and a network interface 1408.

In this example, functions 1410 of the radio access node 1300 described herein are implemented at the one or more processing nodes 1400 or distributed across the control system 1302 and the one or more processing nodes 1400 in any desired manner. In some particular embodiments, some or all of the functions 1410 of the radio access node 1300 described herein are implemented as virtual components executed by one or more virtual machines implemented in a virtual environment(s) hosted by the processing node(s) 1400. As will be appreciated by one of ordinary skill in the art, additional signaling or communication between the processing node(s) 1400 and the control system 1302 is used in order to carry out at least some of the desired functions 1410. Notably, in some embodiments, the control system 1302 may not be included, in which case the radio unit(s) 1310 communicate directly with the processing node(s) 1400 via an appropriate network interface(s).

In some embodiments, a computer program including instructions which, when executed by at least one processor, causes the at least one processor to carry out the functionality of radio access node 1300 or a node (e.g., a processing node 1400) implementing one or more of the functions 1410 of the radio access node 1300 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 15 is a schematic block diagram of the radio access node 1300 according to some other embodiments of the present disclosure. The radio access node 1300 includes one or more modules 1500, each of which is implemented in software. The module(s) 1500 provide the functionality of the radio access node 1300 described herein. This discussion is equally applicable to the processing node 1400 of FIG. 14 where the modules 1500 may be implemented at one of the processing nodes 1400 or distributed across multiple processing nodes 1400 and/or distributed across the processing node(s) 1400 and the control system 1302.

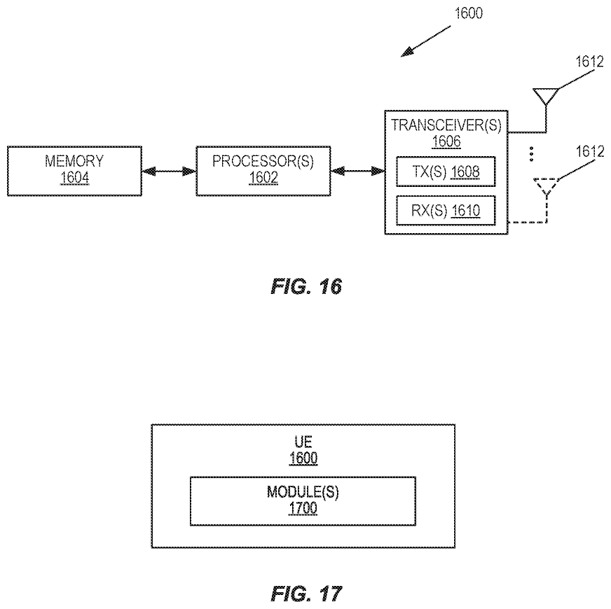

FIG. 16 is a schematic block diagram of a UE 1600 according to some embodiments of the present disclosure. As illustrated, the UE 1600 includes one or more processors 1602 (e.g., CPUs, ASICs, FPGAs, and/or the like), memory 1604, and one or more transceivers 1606 each including one or more transmitters 1608 and one or more receivers 1610 coupled to one or more antennas 1612. The transceiver(s) 1606 includes radio-front end circuitry connected to the antenna(s) 1612 that is configured to condition signals communicated between the antenna(s) 1612 and the processor(s) 1602, as will be appreciated by on of ordinary skill in the art. The processors 1602 are also referred to herein as processing circuitry. The transceivers 1606 are also referred to herein as radio circuitry. In some embodiments, the functionality of the UE 1600 described above may be fully or partially implemented in software that is, e.g., stored in the memory 1604 and executed by the processor(s) 1602. Note that the UE 1600 may include additional components not illustrated in FIG. 16 such as, e.g., one or more user interface components (e.g., an input/output interface including a display, buttons, a touch screen, a microphone, a speaker(s), and/or the like and/or any other components for allowing input of information into the UE 1600 and/or allowing output of information from the UE 1600), a power supply (e.g., a battery and associated power circuitry), etc.

In some embodiments, a computer program including instructions which, when executed by at least one processor, causes the at least one processor to carry out the functionality of the UE 1600 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 17 is a schematic block diagram of the UE 1600 according to some other embodiments of the present disclosure. The UE 1600 includes one or more modules 1700, each of which is implemented in software. The module(s) 1700 provide the functionality of the UE 1600 described herein.

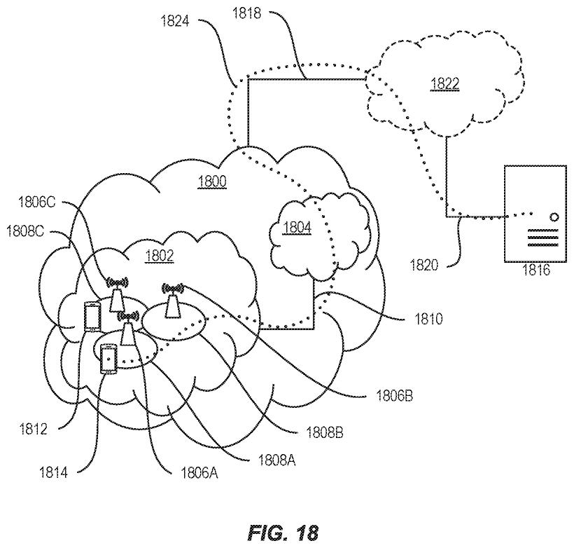

With reference to FIG. 18, in accordance with an embodiment, a communication system includes a telecommunication network 1800, such as a 3GPP-type cellular network, which comprises an access network 1802, such as a RAN, and a core network 1804. The access network 1802 comprises a plurality of base stations 1806A, 1806B, 1806C, such as NBs, eNBs, gNBs, or other types of wireless Access Points (APs), each defining a corresponding coverage area 1808A, 1808B, 1808C. Each base station 1806A, 1806B, 1806C is connectable to the core network 1804 over a wired or wireless connection 1810. A first UE 1812 located in coverage area 1808C is configured to wirelessly connect to, or be paged by, the corresponding base station 1806C. A second UE 1814 in coverage area 1808A is wirelessly connectable to the corresponding base station 1806A. While a plurality of UEs 1812, 1814 are illustrated in this example, the disclosed embodiments are equally applicable to a situation where a sole UE is in the coverage area or where a sole UE is connecting to the corresponding base station 1806.

The telecommunication network 1800 is itself connected to a host computer 1816, which may be embodied in the hardware and/or software of a standalone server, a cloud-implemented server, a distributed server, or as processing resources in a server farm. The host computer 1816 may be under the ownership or control of a service provider, or may be operated by the service provider or on behalf of the service provider. Connections 1818 and 1820 between the telecommunication network 1800 and the host computer 1816 may extend directly from the core network 1804 to the host computer 1816 or may go via an optional intermediate network 1822. The intermediate network 1822 may be one of, or a combination of more than one of, a public, private, or hosted network; the intermediate network 1822, if any, may be a backbone network or the Internet; in particular, the intermediate network 1822 may comprise two or more sub-networks (not shown).

The communication system of FIG. 18 as a whole enables connectivity between the connected UEs 1812, 1814 and the host computer 1816. The connectivity may be described as an Over-the-Top (OTT) connection 1824. The host computer 1816 and the connected UEs 1812, 1814 are configured to communicate data and/or signaling via the OTT connection 1824, using the access network 1802, the core network 1804, any intermediate network 1822, and possible further infrastructure (not shown) as intermediaries. The OTT connection 1824 may be transparent in the sense that the participating communication devices through which the OTT connection 1824 passes are unaware of routing of uplink and downlink communications. For example, the base station 1806 may not or need not be informed about the past routing of an incoming downlink communication with data originating from the host computer 1816 to be forwarded (e.g., handed over) to a connected UE 1812. Similarly, the base station 1806 need not be aware of the future routing of an outgoing uplink communication originating from the UE 1812 towards the host computer 1816.

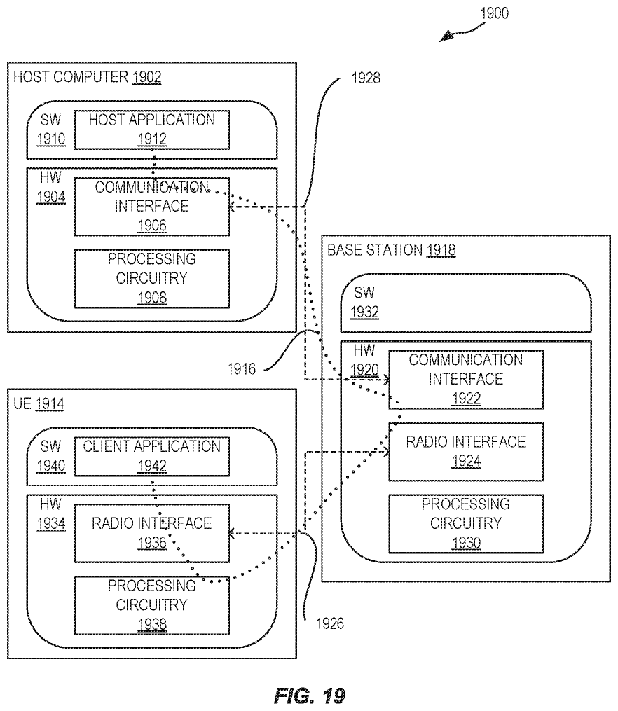

Example implementations, in accordance with an embodiment, of the UE, base station, and host computer discussed in the preceding paragraphs will now be described with reference to FIG. 19. In a communication system 1900, a host computer 1902 comprises hardware 1904 including a communication interface 1906 configured to set up and maintain a wired or wireless connection with an interface of a different communication device of the communication system 1900. The host computer 1902 further comprises processing circuitry 1908, which may have storage and/or processing capabilities. In particular, the processing circuitry 1908 may comprise one or more programmable processors, ASICs, FPGAs, or combinations of these (not shown) adapted to execute instructions. The host computer 1902 further comprises software 1910, which is stored in or accessible by the host computer 1902 and executable by the processing circuitry 1908. The software 1910 includes a host application 1912. The host application 1912 may be operable to provide a service to a remote user, such as a UE 1914 connecting via an OTT connection 1916 terminating at the UE 1914 and the host computer 1902. In providing the service to the remote user, the host application 1912 may provide user data which is transmitted using the OTT connection 1916.

The communication system 1900 further includes a base station 1918 provided in a telecommunication system and comprising hardware 1920 enabling it to communicate with the host computer 1902 and with the UE 1914. The hardware 1920 may include a communication interface 1922 for setting up and maintaining a wired or wireless connection with an interface of a different communication device of the communication system 1900, as well as a radio interface 1924 for setting up and maintaining at least a wireless connection 1926 with the UE 1914 located in a coverage area (not shown in FIG. 19) served by the base station 1918. The communication interface 1922 may be configured to facilitate a connection 1928 to the host computer 1902. The connection 1928 may be direct or it may pass through a core network (not shown in FIG. 19) of the telecommunication system and/or through one or more intermediate networks outside the telecommunication system. In the embodiment shown, the hardware 1920 of the base station 1918 further includes processing circuitry 1930, which may comprise one or more programmable processors, ASICs, FPGAs, or combinations of these (not shown) adapted to execute instructions. The base station 1918 further has software 1932 stored internally or accessible via an external connection.

The communication system 1900 further includes the UE 1914 already referred to. The UE's 1914 hardware 1934 may include a radio interface 1936 configured to set up and maintain a wireless connection 1926 with a base station serving a coverage area in which the UE 1914 is currently located. The hardware 1934 of the UE 1914 further includes processing circuitry 1938, which may comprise one or more programmable processors, ASICs, FPGAs, or combinations of these (not shown) adapted to execute instructions. The UE 1914 further comprises software 1940, which is stored in or accessible by the UE 1914 and executable by the processing circuitry 1938. The software 1940 includes a client application 1942. The client application 1942 may be operable to provide a service to a human or non-human user via the UE 1914, with the support of the host computer 1902. In the host computer 1902, the executing host application 1912 may communicate with the executing client application 1942 via the OTT connection 1916 terminating at the UE 1914 and the host computer 1902. In providing the service to the user, the client application 1942 may receive request data from the host application 1912 and provide user data in response to the request data. The OTT connection 1916 may transfer both the request data and the user data. The client application 1942 may interact with the user to generate the user data that it provides.

It is noted that the host computer 1902, the base station 1918, and the UE 1914 illustrated in FIG. 19 may be similar or identical to the host computer 1816, one of the base stations 1806A, 1806B, 1806C, and one of the UEs 1812, 1814 of FIG. 18, respectively. This is to say, the inner workings of these entities may be as shown in FIG. 19 and independently, the surrounding network topology may be that of FIG. 18.

In FIG. 19, the OTT connection 1916 has been drawn abstractly to illustrate the communication between the host computer 1902 and the UE 1914 via the base station 1918 without explicit reference to any intermediary devices and the precise routing of messages via these devices. The network infrastructure may determine the routing, which may be configured to hide from the UE 1914 or from the service provider operating the host computer 1902, or both. While the OTT connection 1916 is active, the network infrastructure may further take decisions by which it dynamically changes the routing (e.g., on the basis of load balancing consideration or reconfiguration of the network).

The wireless connection 1926 between the UE 1914 and the base station 1918 is in accordance with the teachings of the embodiments described throughout this disclosure. One or more of the various embodiments improve the performance of OTT services provided to the UE 1914 using the OTT connection 1916, in which the wireless connection 1926 forms the last segment. More precisely, the teachings of these embodiments may improve the latency and/or reliability of communication via multiple transmission points when a wireless device has more than one active semi-persistent scheduling configuration active and thereby provide benefits such as improved latency and reliability.

A measurement procedure may be provided for the purpose of monitoring data rate, latency, and other factors on which the one or more embodiments improve. There may further be an optional network functionality for reconfiguring the OTT connection 1916 between the host computer 1902 and the UE 1914, in response to variations in the measurement results. The measurement procedure and/or the network functionality for reconfiguring the OTT connection 1916 may be implemented in the software 1910 and the hardware 1904 of the host computer 1902 or in the software 1940 and the hardware 1934 of the UE 1914, or both. In some embodiments, sensors (not shown) may be deployed in or in association with communication devices through which the OTT connection 1916 passes; the sensors may participate in the measurement procedure by supplying values of the monitored quantities exemplified above, or supplying values of other physical quantities from which the software 1910, 1940 may compute or estimate the monitored quantities. The reconfiguring of the OTT connection 1916 may include message format, retransmission settings, preferred routing, etc.; the reconfiguring need not affect the base station 1918, and it may be unknown or imperceptible to the base station 1918. Such procedures and functionalities may be known and practiced in the art. In certain embodiments, measurements may involve proprietary UE signaling facilitating the host computer 1902's measurements of throughput, propagation times, latency, and the like. The measurements may be implemented in that the software 1910 and 1940 causes messages to be transmitted, in particular empty or ‘dummy’ messages, using the OTT connection 1916 while it monitors propagation times, errors, etc.

FIG. 20 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 20 will be included in this section. In step 2000, the host computer provides user data. In sub-step 2002 (which may be optional) of step 2000, the host computer provides the user data by executing a host application. In step 2004, the host computer initiates a transmission carrying the user data to the UE. In step 2006 (which may be optional), the base station transmits to the UE the user data which was carried in the transmission that the host computer initiated, in accordance with the teachings of the embodiments described throughout this disclosure. In step 2008 (which may also be optional), the UE executes a client application associated with the host application executed by the host computer.

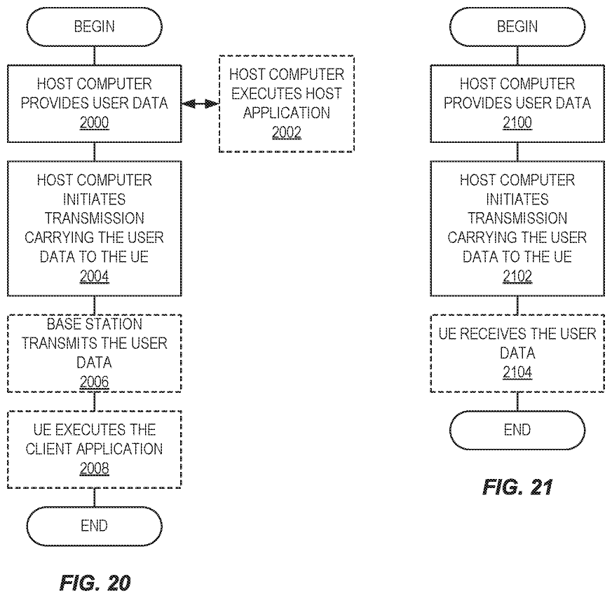

FIG. 21 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 21 will be included in this section. In step 2100 of the method, the host computer provides user data. In an optional sub-step (not shown) the host computer provides the user data by executing a host application. In step 2102, the host computer initiates a transmission carrying the user data to the UE. The transmission may pass via the base station, in accordance with the teachings of the embodiments described throughout this disclosure. In step 2104 (which may be optional), the UE receives the user data carried in the transmission.

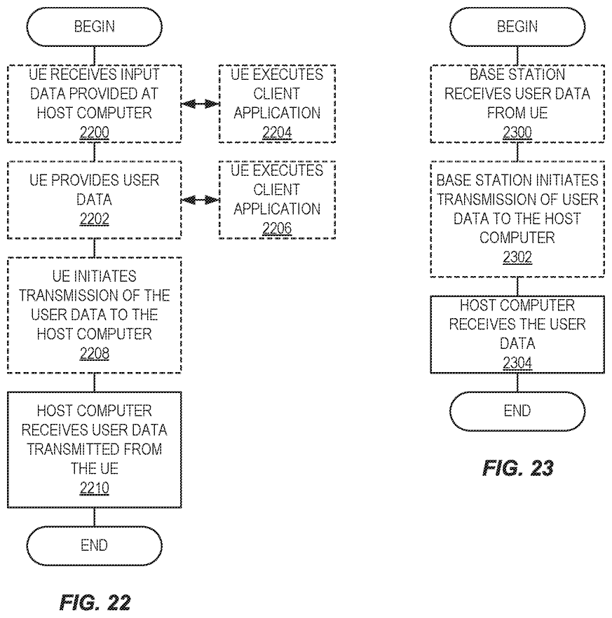

FIG. 22 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 22 will be included in this section. In step 2200 (which may be optional), the UE receives input data provided by the host computer. Additionally or alternatively, in step 2202, the UE provides user data. In sub-step 2204 (which may be optional) of step 2200, the UE provides the user data by executing a client application. In sub-step 2206 (which may be optional) of step 2202, the UE executes a client application which provides the user data in reaction to the received input data provided by the host computer. In providing the user data, the executed client application may further consider user input received from the user. Regardless of the specific manner in which the user data was provided, the UE initiates, in sub-step 2208 (which may be optional), transmission of the user data to the host computer. In step 2210 of the method, the host computer receives the user data transmitted from the UE, in accordance with the teachings of the embodiments described throughout this disclosure.

FIG. 23 is a flowchart illustrating a method implemented in a communication system, in accordance with one embodiment. The communication system includes a host computer, a base station, and a UE which may be those described with reference to FIGS. 18 and 19. For simplicity of the present disclosure, only drawing references to FIG. 23 will be included in this section. In step 2300 (which may be optional), in accordance with the teachings of the embodiments described throughout this disclosure, the base station receives user data from the UE. In step 2302 (which may be optional), the base station initiates transmission of the received user data to the host computer. In step 2304 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Embodiments

### Group A Embodiments

Embodiment 1: A method performed by a wireless device for configuring one or more wireless communications settings, the method comprising one or more of the following: determining a plurality of wireless communications configurations; simultaneously activating at least two of the plurality of wireless communications configurations such that the at least two of the plurality of wireless communications configurations include independent configuration of one or more of a low latency and/or reliability scheme and one or more properties related to the low latency and/or reliability scheme.

Embodiment 2: The method of the previous embodiment wherein simultaneously activating the at least two of the plurality of wireless communications configurations such that the at least two of the plurality of wireless communications configurations include independent configuration of one or more of the low latency and/or reliability scheme and the one or more properties related to the low latency and/or reliability scheme is performed only when the wireless device is simultaneously communicating with multiple transmission points.

Embodiment 3: The method of the previous embodiment wherein the wireless device determines it is communicating with multiple transmission points by receiving multiple TCI states at the wireless device.

Embodiment 4: The method of the previous embodiment wherein receiving multiple TCI states corresponds to reception of downlink SPS from multiple transmission points.

Embodiment 5: The method of any of the previous embodiments wherein the wireless device simultaneously activates the at least two of the plurality of wireless communications configurations in response to an activating DCI.

Embodiment 6: The method of any of the previous embodiments wherein the plurality of wireless communications configurations are semi-persistent scheduling (SPS) configurations.

Embodiment 7: The method of any of the previous embodiments wherein determining the plurality of wireless communications configurations comprises communicating with a network node to determine the plurality of wireless communications configurations.

Embodiment 8: The method of the previous embodiment determining the plurality of wireless communications configurations is done via RRC.

Embodiment 9: The method of any of the previous embodiments wherein the low latency scheme and the reliability scheme include one or more of spatial multiplexing, frequency multiplexing, slot-based time multiplexing, and mini-slot based time multiplexing.

Embodiment 10: The method of any of the previous embodiments wherein the one or more properties related to the low latency scheme and the one or more properties related to the reliability scheme include one or more of an aggregation factor for slot based time repetition, a frequency domain resource allocation information for frequency repetition, a time domain resource allocation information for time repetition, and a configuration of additional TCI states in addition to what is indicated in the activating DCI.

Embodiment 11: The method of any of the previous embodiments wherein the at least two of the plurality of wireless communications configurations are chosen based on a control message from a network node.

Embodiment 12: The method of the previous embodiment wherein the control message is a DCI message.

Embodiment 13: The method of the previous embodiment wherein the at least two of the plurality of wireless communications configurations are chosen based on a TCI field in the DCI message.

Embodiment 14: The method of any of the previous embodiments, further comprising: providing user data; and forwarding the user data to a host computer via the transmission to the base station.

### Group B Embodiments

Embodiment 15: A method performed by a base station for configuring one or more wireless communications settings, the method comprising one or more of the following: communicating with a wireless device such that a plurality of wireless communications configurations are configured for the wireless device; and communicating with the wireless device such that at least two of the plurality of wireless communications configurations are simultaneously activated and the at least two of the plurality of wireless communications configurations include independent configuration of one or more of a low latency and/or reliability scheme and one or more properties related to the low latency and/or reliability scheme.

Embodiment 16: The method of the previous embodiment wherein communicating with the wireless device such that at least two of the plurality of wireless communications configurations are simultaneously activated and the at least two of the plurality of wireless communications configurations include independent configuration of one or more of the low latency and/or reliability scheme and the one or more properties related to the low latency and/or reliability scheme is performed only when the wireless device is simultaneously communicating with at least two transmission points.

Embodiment 17: The method of any of the previous embodiments wherein communicating with the wireless device such that at least two of the plurality of wireless communications configurations are simultaneously activated and the at least two of the plurality of wireless communications configurations include independent configuration of one or more of the low latency and/or reliability scheme and the one or more properties related to the low latency and/or reliability scheme comprises sending an activating DCI to the wireless device.

Embodiment 18: The method of any of the previous embodiments wherein the wireless communications configurations are semi-persistent scheduling (SPS) configurations.

Embodiment 19: The method of any of the previous embodiments wherein communicating with the wireless device such that the plurality of wireless communications configurations are configured for the wireless device is performed via RRC signaling.

Embodiment 20: The method of any of the previous embodiments wherein the low latency scheme and the reliability scheme include one or more of spatial multiplexing, frequency multiplexing, slot-based time multiplexing, and mini-slot based time multiplexing.

Embodiment 21: The method of any of the previous embodiments wherein the one or more properties related to the low latency scheme and the one or more properties related to the reliability scheme include one or more of an aggregation factor for slot based time repetition, a frequency domain resource allocation information for frequency repetition, a time domain resource allocation information for time repetition, and a configuration of additional TCI states in addition to what is indicated in the activating DCI.

Embodiment 22: The method of any of the previous embodiments, further comprising: obtaining user data; and forwarding the user data to a host computer or a wireless device.

### Group C Embodiments

Embodiment 23: A wireless device for configuring one or more wireless communications settings, the wireless device comprising: processing circuitry configured to perform any of the steps of any of the Group A embodiments; and power supply circuitry configured to supply power to the wireless device.

Embodiment 24: A base station for configuring one or more wireless communications settings, the base station comprising: processing circuitry configured to perform any of the steps of any of the Group B embodiments; and power supply circuitry configured to supply power to the base station.

Embodiment 25: A User Equipment, UE, for configuring one or more wireless communications settings, the UE comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 26: A communication system including a host computer comprising: processing circuitry configured to provide user data; and a communication interface configured to forward the user data to a cellular network for transmission to a User Equipment, UE; wherein the cellular network comprises a base station having a radio interface and processing circuitry, the base station's processing circuitry configured to perform any of the steps of any of the Group B embodiments.

Embodiment 27: The communication system of the previous embodiment further including the base station.

Embodiment 28: The communication system of the previous 2 embodiments, further including the UE, wherein the UE is configured to communicate with the base station.

Embodiment 29: The communication system of the previous 3 embodiments, wherein: the processing circuitry of the host computer is configured to execute a host application, thereby providing the user data; and the UE comprises processing circuitry configured to execute a client application associated with the host application.

Embodiment 30: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the base station performs any of the steps of any of the Group B embodiments.

Embodiment 31: The method of the previous embodiment, further comprising, at the base station, transmitting the user data.

Embodiment 32: The method of the previous 2 embodiments, wherein the user data is provided at the host computer by executing a host application, the method further comprising, at the UE, executing a client application associated with the host application.

Embodiment 33: A User Equipment, UE, configured to communicate with a base station, the UE comprising a radio interface and processing circuitry configured to perform the method of the previous 3 embodiments.

Embodiment 34: A communication system including a host computer comprising: processing circuitry configured to provide user data; and a communication interface configured to forward user data to a cellular network for transmission to a User Equipment, UE; wherein the UE comprises a radio interface and processing circuitry, the UE's components configured to perform any of the steps of any of the Group A embodiments.

Embodiment 35: The communication system of the previous embodiment, wherein the cellular network further includes a base station configured to communicate with the UE.

Embodiment 36: The communication system of the previous 2 embodiments, wherein: the processing circuitry of the host computer is configured to execute a host application, thereby providing the user data; and the UE's processing circuitry is configured to execute a client application associated with the host application.

Embodiment 37: A method implemented in a communication system including a host computer, a base station, and a User Equipment, UE, the method comprising: at the host computer, providing user data; and at the host computer, initiating a transmission carrying the user data to the UE via a cellular network comprising the base station, wherein the UE performs any of the steps of any of the Group A embodiments.

Embodiment 38: The method of the previous embodiment, further comprising at the UE, receiving the user data from the base station.

Embodiment 39: A communication system including a host computer comprising: communication interface configured to receive user data originating from a transmission from a User Equipment, UE, to a base station; wherein the UE comprises a radio interface and processing circuitry, the UE's processing circuitry configured to perform any of the steps of any of the Group A embodiments.

Embodiment 40: The communication system of the previous embodiment, further including the UE.

Embodiment 41: The communication system of the previous 2 embodiments, further including the base station, wherein the base station comprises a radio interface configured to communicate with the UE and a communication interface configured to forward to the host computer the user data carried by a transmission from the UE to the base station.

Embodiment 42: The communication system of the previous 3 embodiments, wherein: the processing circuitry of the host computer is configured to execute a host application; and the UE's processing circuitry is configured to execute a client application associated with the host application, thereby providing the user data.

Embodiment 43: The communication system of the previous 4 embodiments, wherein: the processing circuitry of the host computer is configured to execute a host application, thereby providing request data; and the UE's processing circuitry is configured to execute a client application associated with the host application, thereby providing the user data in response to the request data.

Embodiment 44: A method implemented in a communication system including a host computer, a base station, and a User Equipment, UE, the method comprising: at the host computer, receiving user data transmitted to the base station from the UE, wherein the UE performs any of the steps of any of the Group A embodiments.

Embodiment 45: The method of the previous embodiment, further comprising, at the UE, providing the user data to the base station.

Embodiment 46: The method of the previous 2 embodiments, further comprising: at the UE, executing a client application, thereby providing the user data to be transmitted; and at the host computer, executing a host application associated with the client application.

Embodiment 47: The method of the previous 3 embodiments, further comprising: at the UE, executing a client application; and at the UE, receiving input data to the client application, the input data being provided at the host computer by executing a host application associated with the client application; wherein the user data to be transmitted is provided by the client application in response to the input data.

Embodiment 48: A communication system including a host computer comprising a communication interface configured to receive user data originating from a transmission from a User Equipment, UE, to a base station, wherein the base station comprises a radio interface and processing circuitry, the base station's processing circuitry configured to perform any of the steps of any of the Group B embodiments.

Embodiment 49: The communication system of the previous embodiment further including the base station.

Embodiment 50: The communication system of the previous 2 embodiments, further including the UE, wherein the UE is configured to communicate with the base station.

Embodiment 51: The communication system of the previous 3 embodiments, wherein: the processing circuitry of the host computer is configured to execute a host application; and the UE is configured to execute a client application associated with the host application, thereby providing the user data to be received by the host computer.

Embodiment 52: A method implemented in a communication system including a host computer, a base station, and a User Equipment, UE, the method comprising: at the host computer, receiving, from the base station, user data originating from a transmission which the base station has received from the UE, wherein the UE performs any of the steps of any of the Group A embodiments.

Embodiment 53: The method of the previous embodiment, further comprising at the base station, receiving the user data from the UE.

Embodiment 54: The method of the previous 2 embodiments, further comprising at the base station, initiating a transmission of the received user data to the host computer.

### Group D Embodiments

Embodiment 55: A method of configuring a wireless device with plurality of downlink semi-persistent scheduling (SPS) configurations that can be activated simultaneously wherein the plurality of SPS configurations have independent configuration of one or more of the following: independent configuration of low latency and/or reliability schemes which are applicable when multiple TCI states are indicated to the wireless device; and one or more properties related to low latency and/or reliability schemes which are applicable when multiple TCI states are indicated to the wireless device.

Embodiment 56: The method of the first embodiment of Group D where the plurality of downlink SPS are RRC configured.

Embodiment 57: The method of the first embodiment of Group D where the simultaneous activation of the plurality of downlink SPS configurations is done via an activating DCI.

Embodiment 58: The method of any of the first through third embodiments of Group D where the multiple TCI states are indicated to the wireless device by the activating DCI.

Embodiment 59: The method of any of the first through fourth embodiments of Group D, where the indication of multiple TCI states corresponds to reception of downlink SPS from multiple TRPs or multiple panels.

Embodiment 60: The method of any of the first through fifth embodiments of Group D, where if multiple TCI states are not indicated (i.e., a single TCI state is indicated) when activating a given downlink SPS configuration, then the reliability schemes or the properties of the reliability schemes is not configured for the given downlink SPS configuration.

Embodiment 61: The method of any of the first through fifth embodiments of Group D, where if multiple TCI states are not indicated (i.e., a single TCI state is indicated) when activating a given downlink SPS configuration, then the reliability schemes or the properties of the reliability schemes which may be configured for the given downlink SPS configuration are not utilized (i.e., ignored) by the wireless device.

Embodiment 62: The method of any of the first through seventh embodiments of Group D, where the low latency and/or reliability schemes can be any one or a combination of spatial multiplexing, frequency multiplexing, slot-based time multiplexing, mini-slot based time multiplexing.

Embodiment 63: The method of any of the first through seventh embodiments of Group D, where the one or more properties related to low latency and/or reliability schemes may include the configuration of an aggregation factor for slot based time repetition, a frequency domain resource allocation information for frequency repetition, a time domain resource allocation information for time repetition, or a configuration of additional TCI states in addition to what is indicated in the activating DCI.

Embodiment 64: The method of any of the first through ninth embodiments of Group D where the transmission configuration indication field in the activating/deactivating DCI is used to differentiate which DL SPS configuration is to be activated/deactivated.

Embodiment 65: The method of any of the first through tenth embodiments of Group D where the order of TCI states indicated by the codepoint of the transmission configuration indication field may be changed by resending the activating DCI in order to associated different TCI states with different RVs.

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
AF Application Function
AMF Access and Mobility Function
AN Access Network
AP Access Point
ASIC Application Specific Integrated Circuit
AUSF Authentication Server Function
BWP Bandwidth Part
CDM Code Division Multiplexing
CP-OFDM Cyclic Prefix Orthogonal Frequency Division Multiplexing
CPU Central Processing Unit
CRB Common Resource Block
DCI Downlink Channel Information
DFT Discrete Fourier Transform
DFT-S-OFDM DFT Spread Orthogonal Frequency Division Multiplexing
DMRS Demodulation Reference Signal
DN Data Network
DSP Digital Signal Processor
eNB Enhanced or Evolved Node B
FPGA Field Programmable Gate Array
FR Frequency Range
gNB New Radio Base Station
IE Information Element
IIoT Industrial Internet of Things
IoT Internet of Things
IP Internet Protocol
LTE Long Term Evolution
MME Mobility Management Entity
MTC Machine Type Communication
NEF Network Exposure Function
NF Network Function
NR New Radio
NRF Network Function Repository Function
NSSF Network Slice Selection Function
OTT Over-the-Top
PBCH Physical Broadcasting Channel
PCF Policy Control Function
PDCCH Physical Downlink Control Channel
PDCH Physical Data Channel
PDSCH Physical Downlink Shared Channel
P-GW Packet Data Network Gateway
PRB Physical Resource Block
PUSCH Physical Uplink Shared Channel
QCL Quasi Co-Located
QoS Quality of Service
RAM Random Access Memory
RAN Radio Access Network
RB Resource Block
RE Resource Element
ROM Read Only Memory
RRC Radio Resource Control
RRH Remote Radio Head
RU Round Trip Time
RV Redundancy Version
SCEF Service Capability Exposure Function
SINR Signal to Interference plus Noise Ratio
SMF Session Management Function
SPS Semi-Persistent Scheduling
TCI Transmission Configuration Indicator
TDRA Time Domain Resource Allocation
TRP Transmission Reception Point
TRS Tracking Reference Signal
TS Technical Specification
UDM Unified Data Management
UE User Equipment
UPF User Plane Function
URLLC Ultra Reliable Low Latency Communication

Those skilled in the art will recognize improvements and modifications to the embodiments of the present disclosure. All such improvements and modifications are considered within the scope of the concepts disclosed herein.

1. A method performed by a wireless device for configuring one or more wireless communications settings, the method comprising:
determining a plurality of wireless communications configurations; and
simultaneously activating at least two of the plurality of wireless communications configurations such that the at least two of the plurality of wireless communications configurations include configuration of one or more of a low latency and/or reliability scheme and one or more properties related to the low latency and/or reliability scheme.

2. The method of claim 1 wherein simultaneously activating the at least two of the plurality of wireless communications configurations is performed only when the wireless device is simultaneously communicating with multiple transmission points.

3. The method of claim 1 wherein the wireless device applies one or more of the low latency and/or reliability schemes by receiving multiple Transmission Configuration Indication, TCI, states.

4. The method of claim 3 wherein receiving the multiple TCI states corresponds to reception of downlink Semi-Persistent Scheduling, SPS, with the applied low latency and/or reliability scheme.

5. The method of claim 1 wherein the at least two of the plurality of wireless communications configurations in response to an activating Downlink Control Information, DCI, message.

6. The method of claim 1 wherein the plurality of wireless communications configurations are SPS configurations.

7. The method of claim 1 wherein determining the plurality of wireless communications configurations comprises communicating with a network node to determine the plurality of wireless communications configurations.

8. The method of claim 7 wherein determining the plurality of wireless communications configurations is done via Radio Resource Control, RRC.

9. The method of claim 1 wherein the low latency scheme and the reliability scheme include one or more of the group consisting of: spatial multiplexing, frequency multiplexing, slot-based time multiplexing, and mini-slot based time multiplexing.

10. The method of claim 1 wherein the one or more properties related to the low latency scheme and the one or more properties related to the reliability scheme include one or more of the group consisting of: a repetition factor for slot based time repetition, a frequency domain resource allocation information for frequency repetition, a time domain resource allocation information for time repetition, and a configuration of additional TCI states in addition to what is indicated in the activating DCI.

11. The method of claim 1 wherein the at least two of the plurality of wireless communications configurations are chosen based on a control message from the network node.

12. (canceled)

13. The method of claim 1 wherein the one or more of the low latency and/or reliability schemes are chosen based on a TCI field in a DCI message.

14. The method of claim 1 wherein the configuration of one or more of a low latency and/or reliability schemes is independent for each of the plurality of wireless communications configurations.

15. The method of claim 1 wherein a fixed redundancy version sequence is applied when receiving SPS with one of the low latency and/or reliability schemes.

16. A method performed by a base station for configuring one or more wireless communications settings, the method comprising:
communicating with a wireless device such that a plurality of wireless communications configurations is configured for the wireless device; and
communicating with the wireless device such that at least two of the plurality of wireless communications configurations are simultaneously activated and the at least two of the plurality of wireless communications configurations include configuration of one or more of: a low latency and/or reliability scheme and one or more properties related to: the low latency and/or reliability scheme.

17. The method of claim 16 wherein communicating with the wireless device such that the at least two of the plurality of wireless communications configurations are simultaneously activated is performed only when the wireless device is simultaneously communicating with at least two transmission points.

18. (canceled)

19. The method of claim 16 wherein the wireless communications configurations are Semi-Persistent Scheduling, SPS, configurations.

20. (canceled)

21. The method of claim 16 wherein the low latency scheme and the reliability scheme include one or more of the group consisting of: spatial multiplexing, frequency multiplexing, slot-based time multiplexing, and mini-slot based time multiplexing.

22. The method of claim 16 wherein the one or more properties related to the low latency scheme and the one or more properties related to the reliability scheme include one or more of the group consisting of: a repetition factor for slot based time repetition, a frequency domain resource allocation information for frequency repetition, a time domain resource allocation information for time repetition, and a configuration of additional Transmission Configuration Indicator, TCI, states in addition to what is indicated in the activating DCI.

23-28. (canceled)
